(19) United States
(12) Patent Application Publication
(10) Pub. No.: US 2013/0266070 A1
(43) Pub. Date: Oct. 10, 2013

(54) IMAGE PROCESSING DEVICE AND IMAGE PROCESSING METHO

(71) Applicant: Kazushi Sato, Kanagawa (JP)

(72) Inventor: Kazushi Sato, Kanagawa (JP)

(21) Appl. No.: 13/808,726

(22) PCT Filed: Jun. 20, 2011
(86) PCT No.: PCT/JP2011/064046

§ 371 Date: Feb. 13, 2013

(30) Foreign Application Priority Data
Jul. 15, 2010 (JP) 2010-160457

(51) Int. Cl. H04N 7/36

(52) U.S. Cl. CPC H04N 19/00733
USPC 375/240.16

(57) ABSTRACT

Provided is an image processing device including a partitioning section for partitioning a block set in an image into a plurality of partitions by a boundary selected from a plurality of candidates including a boundary having an inclination; and a motion vector prediction section for predicting a motion vector to be used for prediction of a pixel value in each partition in the block partitioned by the partitioning section, based on a motion vector set for a block or a partition corresponding to a reference pixel position that changes according to the inclination of the boundary.

### TECHNICAL FIELD

The present disclosure relates to an image processing device, and an image processing method.

### BACKGROUND ART

Conventionally, a compression technology is widespread that has its object to effectively transmit or accumulate digital images, and that compresses the amount of information of an image by motion compensation and orthogonal transform such as discrete cosine transform, for example, by using redundancy unique to the image. For example, an image encoding device and an image decoding device conforming to a standard technology such as H.26x standards developed by ITU-T or MPEG-y standards developed by MPEG (Moving Picture Experts Group) are widely used in various scenes, such as accumulation and distribution of images by a broadcaster and reception and accumulation of images by a general user.

MPEG2 (ISO/IEC 13818-2) is one of MPEG-y standards defined as a general-purpose image encoding method. MPEG2 is capable of handling both interlaced scanning images and non-interlaced images, and targets high-definition images, in addition to digital images in standard resolution. MPEG2 is currently widely used in a wide range of applications including professional uses and consumer uses. According to MPEG2, for example, by allocating a bit rate of 4 to 8 Mbps to an interlaced scanning image in standard resolution of 720×480 pixels and a bit rate of 18 to 22 Mbps to an interlaced scanning image in high resolution of 1920×1088 pixels, both a high compression ratio and a desirable image quality can be realized.

MPEG2 was primarily for high-quality encoding suitable for broadcasting use, and did not handle a bit rate lower than MPEG1, that is, a high compression ratio. However, with the spread of mobile terminals of recent years, the demand for an encoding method enabling a high compression ratio is increasing. Accordingly, standardization of an MPEG4 encoding method was newly promoted. With regard to an image encoding method which is a part of the MPEG4 encoding method, its standards were accepted as an international standard (ISO/IEC 14496-2) in December 1998.

The H.26x standards (ITU-.T Q6/16 VCEG) are standards developed initially with the aim of performing encoding that is suitable for communications such as video telephones and video conferences. The H.26x standards are known to require a large computation amount for encoding and decoding, but to be capable of realizing a higher compression ratio, compared with the MPEG-y standards. Furthermore, with joint Model of Enhanced-Compression. Video Coding, which is a part of the activities of MPEG4, a standard allowing realization of a higher compression ratio by adopting a new function while being based on the H.26x standards is developed. This standard was made an international standard under the names of H.264 and MPEG-4 Part10 (Advanced Video Coding; AVC) in March 2003.

One of the important techniques in the image encoding method described above is motion compensation. In the case an object is greatly moving in a series of images, a difference between an encoding target image and a reference image becomes great, and a high compression ratio cannot be obtained by simple inter-frame prediction. However, by recognizing motion of the object and compensating pixel values in a region where the motion appears according to the motion, a prediction error based on inter-frame prediction is reduced, and the compression ratio is increased. In MPEG2, motion compensation is performed with 16×16 pixels as a unit of processing in a frame motion compensation mode, and 16×8 pixels as a unit of processing, for each of a first field and a second field, in a field motion compensation mode. Also, in H.264/AVC, a macro block having a size of 16×16 pixels can be partitioned into partition(s) of any of sizes, 16×16 pixel, 16×8 pixels, 8×16 pixels and 8×8 pixels, and a motion vector can be separately set for each partition. Also, a partition of 8×8 pixels can be partitioned into partition(s) of any of sizes, 8×8 pixels, 8×4 pixels, 4×8 pixels and 4×4 pixels, and a motion vector can be set for each partition.

In many cases, a motion vector set for a certain partition is correlated to a motion vector set for a block or a partition in the periphery. For example, in a case one moving object is moving in a series of images, motion vectors for a plurality of partitions belonging to a range reflecting the moving object are the same, or at the least, similar. Furthermore, a motion vector set for a partition may be correlated to a motion vector set for a corresponding partition in a reference image, near in the time direction. Thus, image encoding methods such as MPEG4 and H.264/AVC predict a motion vector using such spatial correlation or temporal correlation of motion, and encode only a difference between a predicted motion vector and an actual motion vector, to thereby reduce the amount of information to he encoded. Also, Non-Patent Literature 1 mentioned below proposes to use a combination of both the spatial correlation and the temporal correlation of motion.

When predicting a motion vector, it is desired that other block or partition correlated with an encoding target partition is appropriately selected. The standard of selection is a reference pixel position. The unit of processing of motion compensation in an existing image encoding method generally has a rectangular shape. Accordingly, normally, pixel position(s) at the top left or top right or both of the rectangle may he selected as the reference pixel position(s) at the time of prediction of a motion vector.

On the other hand, a contour of a moving object appearing in an image has, in many cases, non-horizontal and non-vertical slopes. Accordingly, to more precisely reflect a difference of motion between such moving object and a background in motion compensation, Non-Patent Literature 2 mentioned above proposes, as shown in FIG. 25, to obliquely partition a block by a boundary determined by, a distance ρ from the center point of the block and an inclination angle θ. In the example of FIG. 25, a block BL is partitioned into a first partition PT1 and a second partition PT2 by a boundary BD determined by a distance ρ and an inclination angle θ. Such method is called “geometry motion partitioning”. Also, each partition formed by the geometry motion partitioning is called a geometry partition. Further, a motion compensation process may be performed for each geometry partition formed by the geometry motion partitioning.

### CITATION LIST

### Non-Patent Literature

Non-Patent Literature 1: Jungyoup Yang, Kwanghyun Won, Byeungwoo Jeon, “Motion Vector Coding with Optimal PMV Selection” (VCEG-AI22, July 2008)

Non-Patent Literature 2: Qualcomm Inc., “Video coding technology proposal by Qualcomm Inc.” (JCTVC-A121, April 2010)

### SUMMARY OF INVENTION

### Technical Problem

However, in the case of partitioning a block by a boundary that is neither horizontal nor vertical, as with the geometry motion partitioning, a partition which is a unit of processing of motion compensation may take various shapes other than a rectangle. For example, a block BL1 and a block BL2 shown in FIG. 26 are partitioned into non-rectangular, polygonal geometry partitions by a boundary BD1 and a boundary BD2, respectively. Also, with a prospective image encoding method, it is also conceivable to partition a block by a curved or polygonal boundary (BD3, BD4) such as with a block BL3 and a block BL4 shown in FIG. 26. In these cases, it is difficult to uniformly define a reference pixel position such as the top left or top right of a partition, for example. Non-Patent Literature 2 shows an example of motion vector prediction using a spatial correlation of motion in the geometry motion partitioning, but does not mention how to adaptively set a reference pixel position in a non-rectangular partition.

Thus, the technology according to the present disclosure intends to provide an image processing device and an image processing method which are capable of adaptively setting a reference pixel position and predicting a motion vector in a case a block is partitioned by a partitioning method allowing various shapes other than a rectangle.

### Solution to Problem

According to an embodiment of the present disclosure, there is provided an image processing device including a partitioning section for partitioning a block set in an image into a plurality of partitions by a boundary selected from a plurality of candidates including a boundary having an inclination, and a motion vector prediction section for predicting a motion vector to be used for prediction of a pixel value in each partition in the block partitioned by the partitioning section, based on a motion vector set for a block or a partition corresponding to a reference pixel position that changes according to the inclination of the boundary.

The image processing device may be typically realized as an image encoding device that encodes images. Here, “a block or a partition corresponding to a reference pixel position” may for example, include a block or a partition to which a pixel at the same position as a reference pixel in a reference image (that is, a co-located pixel) belongs. Also, “a block or a partition corresponding to a reference pixel position” may, for example, include a block or a partition to which a pixel adjacent to a reference pixel in the same image belongs.

Further, the image processing device may further include a reference pixel setting section for setting the reference pixel position for each partition according to the inclination of the boundary.

Further, in a case the boundary overlaps a first corner or a second corner of the block that are located opposite each other, the reference pixel setting section may set the reference pixel position of each partition of the block to a third corner or a fourth corner different from the first corner and the second corner.

Further, the first corner is a corner at a top left of the block, and in a case the boundary does not overlap the first corner and the second corner, the reference pixel setting section may set the reference pixel position of a first partition to which the first corner belongs to the first corner.

Further, in a case the boundary does not overlap the first corner and the second corner, and the second corner belongs to a second partition to which the first corner does not belong, the reference pixel setting section may set the reference pixel position of the second partition to the second corner.

Further, the motion vector prediction section may predict the motion vector using a prediction formula that is based on a motion vector set for a block or a partition, in a reference image, corresponding to the reference pixel position.

Further, the motion vector prediction section may predict the motion vector using a prediction formula that is based on a motion vector set for a block or a partition, in a reference image, corresponding to the reference pixel position and a motion vector set for another block or partition adjacent to the reference pixel position.

Further, the motion vector prediction section may predict the motion vector using a first prediction formula that is based on a motion vector set for a block or a partition, in a reference image, corresponding to the reference pixel position, and predict the motion vector using a second prediction formula that is based on a motion vector set for another block or partition adjacent to the reference pixel position. The image processing device may further include a selection section for selecting a prediction formula that achieves a highest encoding efficiency from a plurality of prediction formula candidates including the first prediction formula and the second prediction formula, based on a prediction result of the motion vector prediction section.

Further, according to an embodiment of the present disclosure, there is provided an image processing method for processing an image, including partitioning a block set in an image into a plurality of partitions by a boundary selected from a plurality of candidates including a boundary having an inclination, and predicting a motion vector to be used for prediction of a pixel value in each partition in the block which has been partitioned, based on a motion vector set for a block or a partition corresponding to a reference pixel position that changes according to the inclination of the boundary.

Further, according to an embodiment of the present disclosure, there is provided an image processing device including a boundary recognition section for recognizing an inclination of a boundary, selected from a plurality of candidates including a boundary having an inclination, that partitioned a block in an image at a time of encoding of the image, and a motion vector setting section for setting a motion vector to be used for prediction of a pixel value in each partition in a block partitioned by the boundary, based on a motion vector set for a block or a partition corresponding to a reference pixel position that changes according to the inclination of the boundary.

The image processing device may be typically realized as an image decoding device that decodes images.

Further, the image processing device may further include a reference pixel setting section for setting the reference pixel position for each partition according to the inclination of the boundary recognized by the boundary recognition section.

Further, in a case the boundary overlaps a first corner or a second corner of the block that are located opposite each other, the reference pixel setting section may set the reference pixel position of each partition of the block to a third corner or a fourth corner different from the first corner and the second corner.

Further, the first corner is a corner at a top left of the block, and in a case the boundary does not overlap the first corner and the second corner, the reference pixel setting section may set the reference pixel position of a first partition to which the first corner belongs to the first corner.

Further, in a case the boundary does not overlap the first corner and the second corner, and the second corner belongs to a second partition to which the first corner does not belong, the reference pixel setting section may set the reference pixel position of the second partition to the second corner.

Further, the motion vector setting section may identify, based on information that is acquired in association with each partition, a prediction formula for a motion vector selected for the partition at a time of encoding.

Further, candidates for the prediction formula to be selected at a time of encoding may include a prediction formula that is based on a motion vector set for a block or a partition, in a reference image, corresponding to the reference pixel position.

Further, candidates for the prediction formula to be selected at a time of encoding may include a prediction formula that is based on a motion vector set for a block or a partition, in a reference image, corresponding to the reference pixel position and a motion vector set for another block or partition adjacent to the reference pixel position.

Further, according to an embodiment of the present disclosure, there is provided an image processing method for processing an image, including recognizing an inclination of a boundary, selected from a plurality of candidates including a boundary having an inclination, that partitioned a block set in an image at a time of encoding of the image, and setting a motion vector to he used for prediction of a pixel value in each partition in the block partitioned by the boundary, based on a motion vector set for a block or a partition corresponding to a reference pixel position that changes according to the inclination of the boundary.

### Advantageous Effects of Invention

As described above, according to the image processing device and the image processing method of the present disclosure, a reference pixel position can be adaptively set and a motion vector can be predicted in a case a block is partitioned by a partitioning method allowing various shapes other than a rectangle.

### BRIEF DESCRIPTION OF DRAWINGS

FIG. 1 is a block diagram showing an example of a configuration of an image encoding device according to an embodiment.

FIG. 2 is a block diagram showing an example of a detailed configuration of a motion estimation section of an image encoding device of an embodiment.

FIG. 3 is a first explanatory diagram for describing partitioning of a block into rectangular partitions.

FIG. 4 is a second explanatory diagram for describing partitioning of a block into rectangular partitions.

FIG. 5 is an explanatory diagram for describing partitioning of a block into non-rectangular partitions.

FIG. 6 is an explanatory diagram for describing a reference pixel position which may be set in a rectangular partition.

FIG. 7 is an explanatory diagram for describing spatial prediction in a rectangular partition.

FIG. 8 is an explanatory diagram for describing temporal prediction in a rectangular partition.

FIG. 9 is an explanatory diagram for describing a multi-reference frame.

FIG. 10 is an explanatory diagram for describing a temporal direct mode.

FIG. 11 is a first explanatory diagram for describing a reference pixel position which may be set in a non-rectangular partition.

FIG. 12 is a second explanatory diagram for describing a reference pixel position which may be set in a non-rectangular partition.

FIG. 13 is a third explanatory diagram for describing a reference pixel position which may be set in a non-rectangular partition.

FIG. 14 is an explanatory diagram for describing spatial prediction in a non-rectangular partition.

FIG. 15 is an explanatory diagram for describing temporal prediction in a non-rectangular partition.

FIG. 16 is a flow chart showing an example of a flow of a reference pixel position setting process according to an embodiment.

FIG. 17 is a flow chart showing an example of a flow of a motion estimation process according to an embodiment.

FIG. 18 is a block diagram showing an example of a configuration of an image decoding device according to an embodiment.

FIG. 19 is a block diagram showing an example of a detailed configuration of a motion compensation section of an image decoding device according to an embodiment.

FIG. 20 is a flow chart showing an example of a flow of a motion compensation process according to an embodiment.

FIG. 21 is a block diagram showing an example of a schematic configuration of a television.

FIG. 22 is a block diagram showing an example of a schematic configuration of a mobile phone.

FIG. 23 is a block diagram showing an example of a schematic configuration of a recording/reproduction device.

FIG. 24 is a block diagram showing an example of a schematic configuration of an image capturing device,

FIG. 25 is an explanatory diagram showing an example of partitioning of a block by geometry motion partitioning.

FIG. 26 is an explanatory diagram showing another example of partitioning of a block into non-rectangular partitions.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

Furthermore, the “Description of Embodiments” will be described in the order mentioned below

1. Example Configuration of Image Encoding Device According to an Embodiment

2. Flow of Process at the Time of Encoding According to an Embodiment

3. Example Configuration of Image Decoding Device According to an Embodiment

4. Flow of Process at the. Time of Decoding According to an Embodiment

5. Example Application

6. Summary

### 1. EXAMPLE CONFIGURATION OF IMAGE ENCODING DEVICE ACCORDING TO AN EMBODIMENT

### 1-1. Example of Overall Configuration

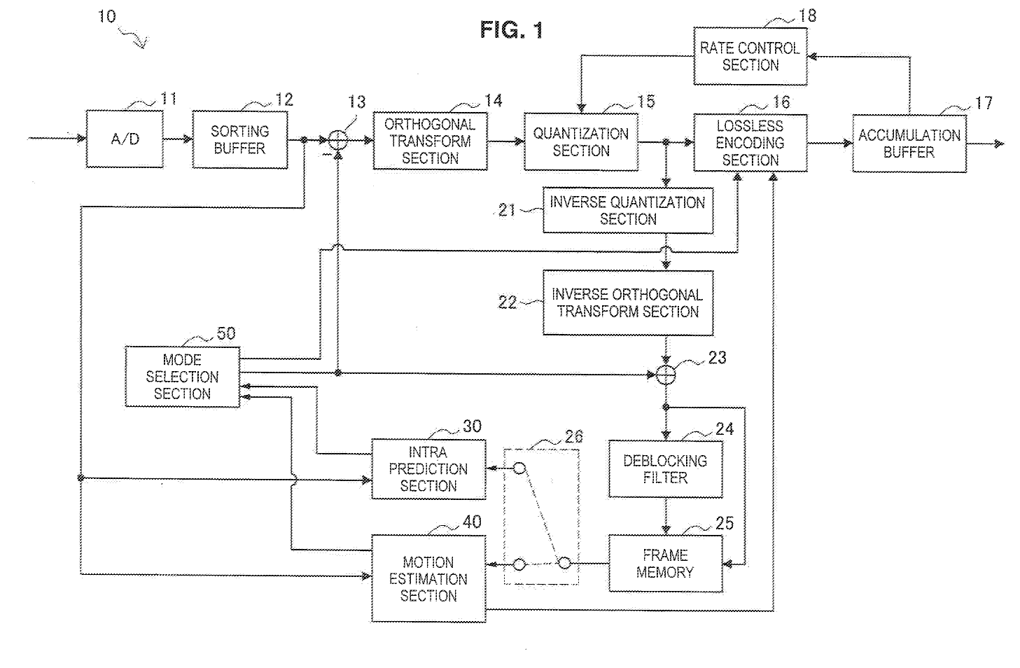

FIG. 1 is a block diagram showing an example of a configuration of an image encoding device 10 according to an embodiment. Referring to FIG. 1, the image encoding device 10 includes an A/D (Analogue to Digital) conversion section 11, a sorting buffer 12, a subtraction section 13, an orthogonal transform section 14, a quantization section 15, a lossless encoding section 16, an accumulation buffer 17, a rate control section 18, an inverse quantization section 21, an inverse orthogonal transform section 22, an addition section 23, a deblocking filter 24, a frame memory 25, a selector 26, an intra prediction section 30, a motion estimation section 40, and a mode selection section 50.

The A/D conversion section 11 converts arm image signal input in an analogue format into image data in a digital format, and outputs a series of digital image data to the sorting buffer 12.

The sorting buffer 12 sorts the images included in the series of image data input from the A/D conversion section 11. After sorting the images according to the a GOP (Group of Pictures) structure according to the encoding process, the sorting buffer 12 outputs the image data which has been sorted to the subtraction section 13, the intra prediction section 30, and the motion estimation section 40.

The image data input from the sorting buffer 12 and predicted image data selected by the mode selection section 50 described later are supplied to the subtraction section 13. The subtraction section 13 calculates predicted error data which is a difference between the image data input from the sorting buffer 12 and the predicted image data input from the mode selection section 50, and outputs the calculated predicted error data to the orthogonal transform section 14.

The orthogonal transform section 14 performs orthogonal transform on the predicted error data input from the subtraction section 13. The orthogonal transform to be performed by the orthogonal transform section 14 may be discrete cosine transform (DCT) or Karhunen-Loeve transform, for example. The orthogonal transform section 14 outputs transform coefficient data acquired by the orthogonal transform process to the quantization section 15.

The transform coefficient data input from the orthogonal transform section 14 and a rate control signal from the rate control section 18 described later are supplied to the quantization section 15. The quantization section 15 quantizes the transform coefficient data, and outputs the transform coefficient data which has been quantized (hereinafter, referred to as quantized data) to the lossless encoding section 16 and the inverse quantization section 21. Also, the quantization section 15 switches a quantization parameter (a quantization scale) based on the rate control signal from the rate control section 18 to thereby change the bit rate of the quantized data to be input to the lossless encoding section 16.

The quantized data input from the quantization section 15 and information described later about intra prediction or inter prediction generated by the intra prediction section 30 or the motion estimation section 40 and selected by the mode selection section 50 are supplied to the lossless encoding section 16. The information about intra prediction may include prediction mode information indicating an optimal intra prediction mode for each block, for example. Also, the information about inter prediction may include partition information identifying a boundary which has partitioned each block, prediction formula information identifying a prediction formula used for prediction of a motion vector for each partition, difference motion vector information, reference image information, and the like, for example.

The lossless encoding section 16 generates an encoded stream by performing a lossless encoding process on the quantized data. The lossless encoding by the lossless encoding section 16 may be variable-length coding or arithmetic coding, for example. Furthermore, the lossless encoding section 16 multiplexes the information about intra prediction or the information about inter prediction mentioned above to the header of the encoded stream (for example, a block header, a slice header or the like). Then, the lossless encoding section 16 outputs the generated encoded stream to the accumulation buffer 17.

The accumulation buffer 17 temporarily stores the encoded stream input from the lossless encoding section 16 using a storage medium, such as a semiconductor memory. Then, the accumulation buffer 17 outputs the accumulated encoded stream at a rate according to the band of a transmission line (or an output line from the image encoding device 10).

The rate control section 18 monitors the free space of the accumulation buffer 17. Then, the rate control section 18 generates a rate control signal according to the free space on the accumulation buffer 17, and outputs the generated rate control signal to the quantization section 15. For example, when there is not much free space on the accumulation buffer 17, the rate control section 18 generates a rate control signal for lowering the bit rate of the quantized data. Also, for example, when the free space on the accumulation buffer 17 is sufficiently large, the rate control section 18 generates a rate control signal for increasing the bit rate of the quantized data.

The inverse quantization section 21 performs an inverse quantization process on the quantized data input from the quantization section 15. Then, the inverse quantization section 21 outputs transform coefficient data acquired by the inverse quantization process to the inverse orthogonal transform section 22.

The inverse orthogonal transform section 22 performs an inverse orthogonal transform process on the transform coefficient data input from the inverse quantization section 21 to thereby restore the predicted error data. Then, the inverse orthogonal transform section 22 outputs the restored predicted error data to the addition section 23.

The addition section 23 adds the restored predicted error data input from the inverse orthogonal transform section 22 and the predicted image data input from the mode selection section 50 to thereby generate decoded image data. Then, the addition section 23 outputs the generated decoded image data to the deblocking filter 24 and the frame memory 25.

The deblocking filter 24 performs a filtering process for reducing block distortion occurring at the time of encoding of an image. The deblocking filter 24 filters the decoded image data input from the addition section 23 to remove the block distortion, and outputs the decoded image data after filtering to the frame memory 25.

The frame memory 25 stores, using a storage medium, the decoded image data input from the addition section 23 and the decoded image data after filtering input from the deblocking filter 24.

The selector 26 reads, from the frame memory 25, the decoded image data before filtering that is to be used for the intra prediction, and supplies the decoded image data which has been read to the intra prediction section 30 as reference image data. Also, the selector 26 reads, from the frame memory 25, the decoded image data after filtering to be used for the inter prediction, and supplies the decoded image data which has been read to the motion estimation section 40 as reference image data.

The intra prediction section 30 performs an intra prediction process in each intra prediction mode defined by H.264/AVC, based on the encoding target image data that is input from the sorting buffer 12 and the decoded image data supplied via the selector 26. For example, the intra prediction section 30 evaluates the prediction result of each intra prediction mode using a predetermined cost function. Then, the intra prediction section 30 selects an intra prediction mode by which the cost function value is the smallest, that is, an intra prediction mode by which the compression ratio is the highest, as the optimal intra prediction mode. Furthermore, the intra prediction section 30 outputs, to the mode selection section 50, prediction mode information indicating the optimal intra prediction mode, the predicted image data, and the information about intra prediction such as the cost function value. Moreover, the intra prediction section 30 may perform the intra prediction process with a larger block than each intra prediction mode defined by H.264/AVC, based on the encoding target image data input from the sorting buffer 12 and the decoded image data supplied via the selector 26. Also in this case, the intra prediction section 30 evaluates the prediction result of each intra prediction mode using a predetermined cost function, and outputs, to the mode selection section 50, the information about intra prediction for the optimal intra prediction mode.

The motion estimation section 40 performs a motion estimation process with each block set in an image as a target, based on the encoding target image data input from the sorting buffer 12 and the decoded image data as reference image data supplied from frame memory 25.

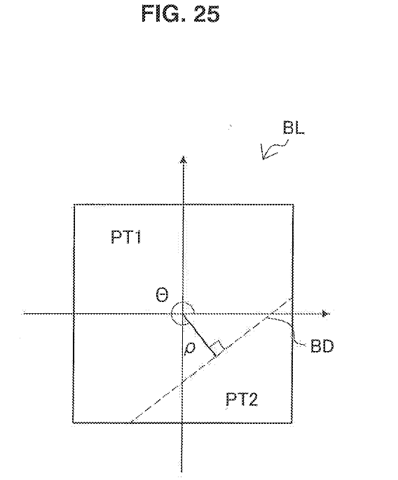

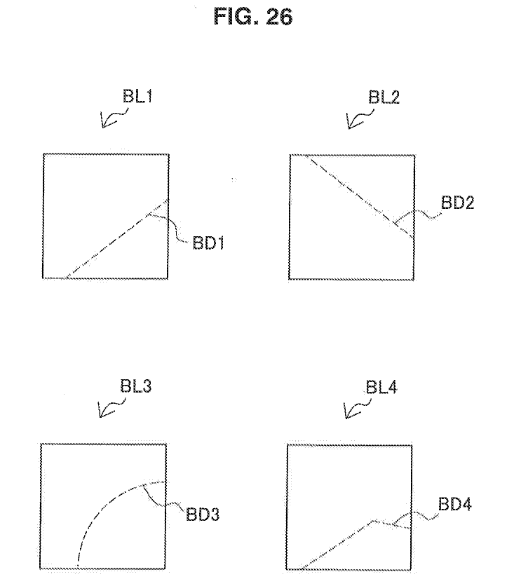

More specifically, the motion estimation section 40 partitions each block into a plurality of partitions by a plurality of boundary candidates. The boundary candidates for partitioning a block include boundaries having an inclination as illustrated in FIGS. 25 and 26, in addition to a boundary along a horizontal direction or a vertical direction of H.264/AVC, for example. Further, the motion estimation section 40 calculates a motion vector for each partition based on a pixel value of a reference image and a pixel value of an original image in each partition.

Furthermore, the motion estimation section 40 adaptively sets a reference pixel position for each partition according to the inclination of the boundary. Then, the motion estimation section 40 predicts, for each partition, a motion vector to be used for prediction of a pixel value in an encoding target partition, based on a motion vector already calculated for a block or a partition corresponding to the reference pixel position which has been set. Prediction of a motion vector may be performed for each of a plurality of prediction formula candidates. A plurality of prediction formula candidates may include a prediction formula that uses spatial correlation, temporal correlation, or both, for example. Accordingly, the motion estimation section 40 predicts a motion vector for each partition for each combination of a boundary candidate and a prediction formula candidate. Then, the motion estimation section 40 selects, as an optimal combination, a combination of a boundary and a prediction formula by which a cost function value according to a predetermined cost function becomes the smallest (i.e., which results in the highest compression ratio).

Such estimation process of the motion estimation section 40 will be further described later citing specific examples regarding partitioning. The motion estimation section 40 outputs to the mode selection section 50, as the results of the motion estimation process, the information about inter prediction such as partition information identifying an optimal boundary, prediction formula information identifying an optimal prediction formula, the difference motion vector information, the cost function value and the like, and the predicted image data.

The mode selection section 50 compares the cost function value related to the intra prediction input from the intra prediction section 30 and the cost function value related to the inter prediction input from the motion estimation section 40. Then, the mode selection section 50 selects a prediction method with a smaller cost function value, from the intra prediction and the inter prediction. In the case of selecting the intra prediction, the mode selection section 50 outputs the information about intra prediction to the lossless encoding section 16, and also, outputs the predicted image data to the subtraction section 13 and the addition section 23. Also, in the case of selecting the inter prediction, the mode selection section 50 outputs the information about inter prediction described above to the lossless encoding section 16, and also, outputs the predicted image data to the subtraction section 13 and the addition section 23.

### 1-2. Example Configuration of Motion Estimation Section

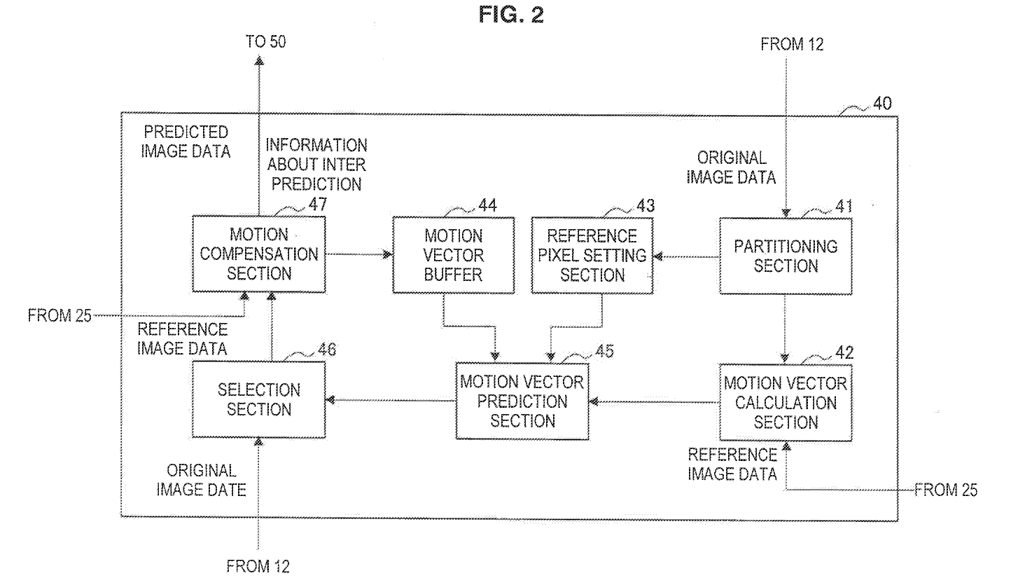

FIG. 2 is a block diagram showing an example of a detailed configuration of the motion estimation section 40 of the image encoding device 10 shown in FIG. 1. Referring to FIG. 2, the motion estimation section 40 includes a partitioning section 41, a motion vector calculation section 42, a reference pixel setting section 43, a motion vector buffer 44, a motion vector prediction section 45, a selection section 46, and a motion compensation section 47.

The partitioning section 41 partitions a block set in an image into a plurality of partitions by a boundary selected from a plurality of candidates including a boundary having an inclination.

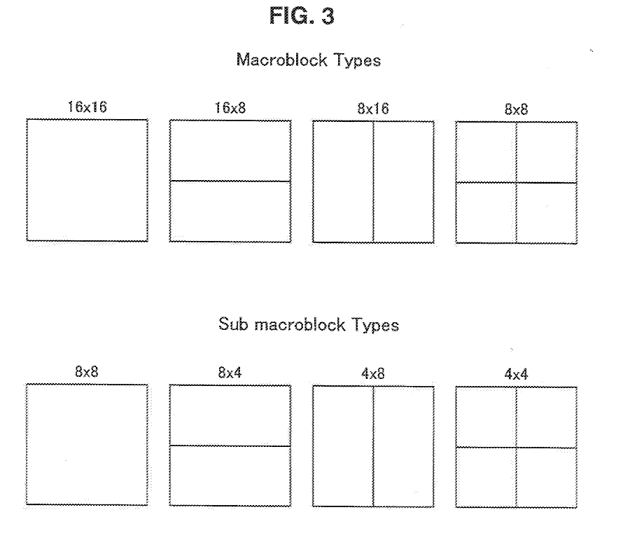

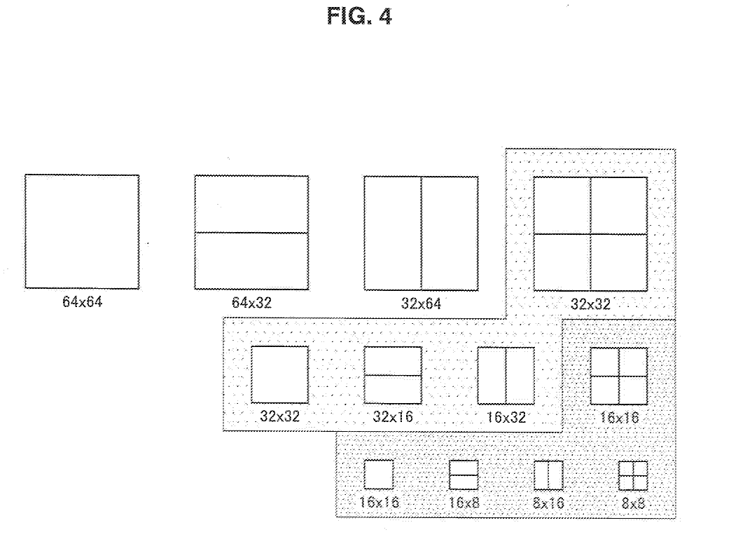

The partitioning section 41 may partition a block set in an image by a boundary candidate, having no inclination, along the horizontal direction or the vertical direction, as shown in FIGS. 3 and 4, for example. In this case, each partition formed by the partitioning is a rectangular partition. In the example of FIG. 3, a largest macro block of 16×16 pixels may be partitioned into two blocks of 16×8 pixels by a horizontal boundary. Also, a largest macro block of 16×16 pixels may be partitioned into two blocks of 8×16 pixels by a vertical boundary. Furthermore, a largest macro block of 16×16 pixels may be partitioned into four blocks of 8×8 pixels by a horizontal boundary and a vertical boundary. Still further, a macro block of 8×8 pixels may be partitioned into two sub-macro blocks of 8×4 pixels, two sub-macro blocks of 4×8 pixels, or four sub-macro blocks of 4×4 pixels. Also, as shown in FIG. 4, the partitioning section 41 may partition a block of an extended size (for example, 64×64 pixels), larger than a largest macro block of 16×16 pixels supported by H.264/AVC, into rectangular partitions, for example.

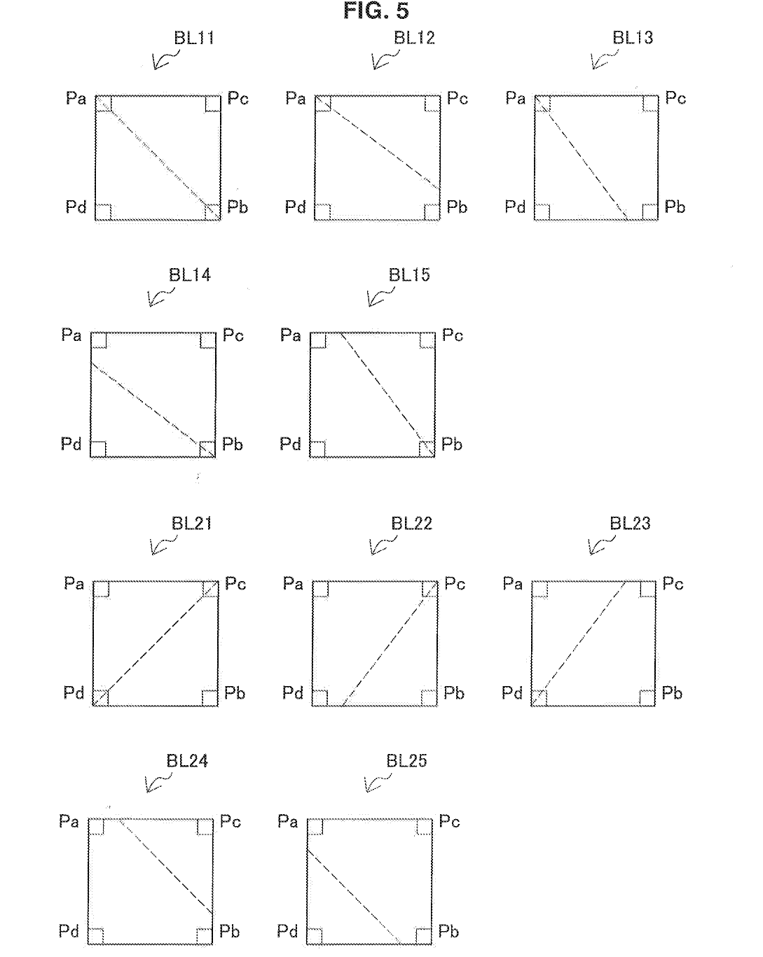

Furthermore, as shown in FIG. 5, the partitioning section 41 partitions a block set in an image by a boundary candidate having an inclination, for example. In this case, each partition formed by the partitioning may be a non-rectangular partition. In the example of FIG. 5, ten types of blocks BL11 to BL15, and BL21 to BL25 which are partitioned by boundaries having an inclination are shown. Additionally, with the geometry motion partitioning, the position and inclination of a boundary having an inclination in a block are identified by a distance ρ and an inclination angle θ (see FIG. 25). The partitioning section 41 discretely specifies some candidates for the values of the distance ρ and the inclination angle θ, for example. In this case, a boundary identified by a combination of specified distance ρ and inclination angle θ is the candidate for a boundary for partitioning a block. In the example of FIG. 5, the shape of each partition formed by the partitioning is a triangle, a trapezoid, or a pentagon.

The partitioning section 41 partitions a block by boundaries which are the plurality of candidates (that is, by a plurality of partitioning patterns), and outputs partition information identifying the boundaries as the candidates to the motion vector calculation section 42 and the reference pixel setting section 43. The partition information may include partitioning mode information specifying either of rectangular partitioning and the geometry motion partitioning, and a boundary parameter specifying the position and the inclination of a boundary (for example, the distance ρ and the inclination angle θ described above), for example.

The motion vector calculation section 43 calculates a motion vector for each partition identified by the partition information input from the partitioning section 41, based on a pixel value of an original image and a pixel value of a reference image input from the frame memory 25. At the time of calculating the motion vector, the motion vector calculation section 43 may, for example, interpolate a median pixel value of adjacent pixels by a linear interpolation process, and calculate a motion vector with ½-pixel accuracy. Also, the motion vector calculation section 43 may further interpolate a median pixel value using a 6-tap FIR filter, for example, and calculate a motion vector with ¼-pixel accuracy. The motion vector calculation section 43 outputs the calculated motion vector to the motion vector prediction section 45.

The reference pixel setting section 43 sets a reference pixel position for each partition in a block according to the inclination of a boundary which has partitioned the block. For example, in the case a block is partitioned by a boundary, having no inclination, along the horizontal direction or the vertical direction, the reference pixel setting section 43 sets the pixel positions at the top left and the top right of a rectangular partition formed by the partitioning as the reference pixel positions for the prediction of a motion vector. On the other hand, in the case a block partitioned by a boundary having an inclination, such as in the case of the geometry motion partitioning, the reference pixel setting section 43 adaptively sets a reference pixel position according to the inclination of the boundary, in a non-rectangular partition formed by the partitioning. A reference pixel position set by the reference pixel setting section 43 will be further described later by citing an example.

The motion vector buffer 44 temporarily stores, using a storage medium, a reference motion vector which is referred to in a motion vector prediction process of the motion vector prediction section 45. A motion vector which is referred to in a motion vector prediction process may include a motion vector set for a block or a partition in a reference image which is already encoded, and a motion vector set for another block or partition in an encoding target image.

The motion vector prediction section 45 predicts a motion vector to be used for prediction of a pixel value in each partition in a block partitioned by the partitioning section 41, based on a motion vector set for a block or a partition corresponding to a reference pixel position set by the reference pixel setting section 43. As described above, “a block or a partition corresponding to a reference pixel position” here may include a block or a partition to which a pixel adjacent to a reference pixel belongs, for example. Also, “a block or a partition corresponding to a reference pixel position” may include a block or a partition to which a pixel which is at the same position as a reference pixel in a reference image belongs, for example.

The motion vector prediction section 45 may predict a plurality of motion vectors for one partition using a plurality of prediction formulae. For example, a first prediction formula may be a prediction formula that uses a spatial correlation of motion, and a second prediction formula may be a prediction formula that uses a temporal correlation of motion. Also, a prediction formula that uses both the spatial correlation and the temporal correlation of motion may be used as a third prediction formula. In the case of using the spatial correlation of motion, the motion vector prediction section 45 refers to a reference motion vector that is set for another block or partition adjacent to a reference pixel position and stored in the motion vector buffer 44, for example. Also, in the case of using the temporal correlation of motion, the motion vector prediction section 45 refers to a reference motion vector that is set for a block or a partition, co-located with a reference pixel position, in a reference image and stored in the motion vector buffer 44, for example. A prediction formula that may be used by the motion vector prediction section 45 will be further described later by citing an example.

After calculating a predicted motion vector using one prediction formula for a partition related to a certain boundary; the motion vector prediction section 45 calculates a difference motion vector representing a difference between the motion vector calculated by the motion vector calculation section 42 and the predicted motion vector. Then, the motion vector prediction section 45 associates the partition information identifying the boundary mentioned above and the prediction formula information identifying the prediction formula mentioned above, and outputs the calculated difference motion vector and the reference image information to the selection section 46.

The selection section 46 selects a combination of an optimal boundary and an optimal prediction formula by which the cost function value will be the smallest, using the partition information, the prediction information and the difference motion vector input from the motion vector prediction section 45. Then, the selection section 46 outputs, to the motion compensation section 47, partition information identifying the selected optimal boundary, prediction formula information identifying the optimal prediction formula, corresponding difference motion vector information, the reference image information, a corresponding cost function value, and the like.

The motion compensation section 47 generates predicted image data using the optical boundary selected by the selection section 46, the optical prediction formula, the difference motion vector, and the reference image data input from the frame memory 25. Then, the motion compensation section 47 outputs, to the mode selection section 50, the generated predicted image data, and the information about inter prediction, input from the selection section 46, such as the partition information, the prediction formula information, the difference motion vector information, the cost function value, and the like. Also, the motion compensation section 47 stores in the motion vector buffer 44 the motion vector used for the generation of the predicted image data, that is, the motion vector that is finally set for each partition.

### 1-3. Explanation on Motion Vector Prediction Process

Next, the motion vector prediction process of the motion vector prediction section 43 described above will be more specifically described.

### (1) Prediction of Motion Vector in Rectangular Partition

### (1-1) Reference Pixel Position

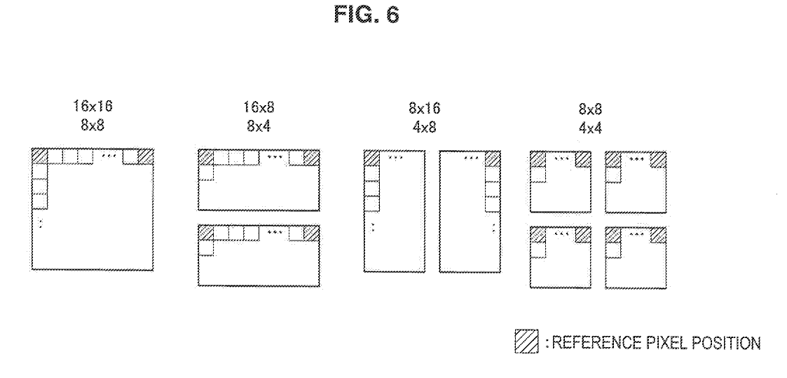

FIG. 6 is an explanatory diagram for describing a reference pixel position which may be set in a rectangular partition. Referring to FIG. 6, a rectangular block (16×16 pixels) not partitioned by a boundary, and rectangular partitions each partitioned by a horizontal or vertical boundary are shown. The reference pixel setting section 43 uniformly sets, for these rectangular partitions, reference pixel position(s) for prediction of a motion vector at the top left, the top right, or both in each partition. In FIG. 6, these reference pixel positions are shown by diagonal shades. Additionally, in H.264/AVC, a reference pixel position in a partition of 8×16 pixels is set at the top left of a partition which is on the left side in the block, and at the top right for a partition on the right side in the block.

### (1-2) Spatial Prediction

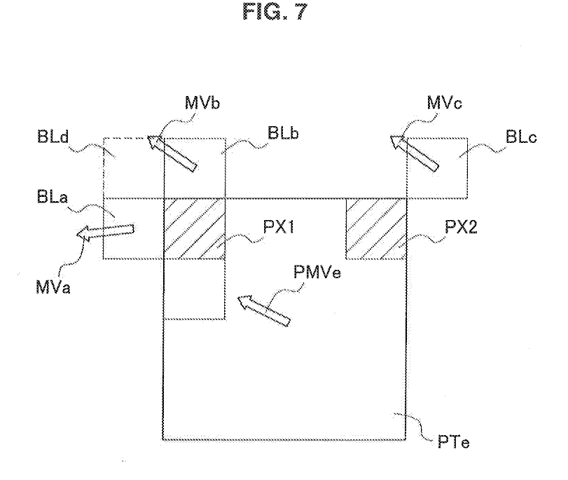

FIG. 7 is an explanatory diagram for describing spatial prediction in a rectangular partition. Referring to FIG. 7, two reference pixel positions, PX1 and PX2, which may be set in one rectangular partition PTe are shown. A prediction formula that uses spatial correlation of motion has, as inputs, motion vectors set for other blocks or partitions adjacent to these reference pixel positions PX1 and PX2. Additionally, in the present specification, the term “adjacent” includes not only a case where two blocks, partitions or pixels share a side, but also a case where a vertex is shared.

For example, a motion vector set for a block BLa to which a pixel at the left of the reference pixel position PX1 belongs to is taken as MVa. Also, a motion vector set for a block BLb to which a pixel above the reference pixel position PX1 belongs is taken as MVb. Further, a motion vector set to a block BLc to which a pixel at the top right of the reference pixel position PX2 belongs is taken as MVc. These motion vectors MVa, MVb and MVc are already encoded. A predicted motion vector PMVe for the rectangular partition PTe in the encoding target block may be calculated from the motion vectors MVa, MVb and MVc using a prediction formula as follows.

[Math. 1]

PMVe=med(MVa, MVb, MVc) (1)

Here, fined in formula (1) represents an median operation. That is, according to formula (1), the predicted motion vector PMVe is a vector that takes median values of a horizontal component and a median value of a vertical component, of the motion vectors MVa, MVb and MVc, as the components. Additionally, formula (1) described above is merely an example of a prediction formula that uses spatial correlation. For example, in the case any of the motion vectors MVa, MVb and MVc does not exist because an encoding target block is located at an end portion of an image, the non-existent motion vector may be omitted from the arguments of the median operation. Also, for example, in the case an encoding target block is located at the right end of an image, a motion vector set for the block BLd shown in FIG. 7 may be used instead of the motion vector MVc.

Additionally, the predicted motion vector PMVe is also referred to as a predictor. Particularly, a predicted motion vector calculated by the prediction formula that uses spatial correlation of motion, as the formula (1), is referred to as a spatial predictor. On the other hand, a predicted motion vector that is calculated by the prediction formula that uses temporal correlation of motion that is described in the following section is referred to as a temporal predictor.

After deciding the predicted motion vector PMVe in this manner, the motion vector prediction section 45 calculates a difference motion vector MVDe representing the difference between the motion vector MVe calculated by the motion vector calculation section 42 and the predicted motion vector PMVe in the manner of the following formula.

[Math. 2]

MVDe=MVe−PMVe (2)

The difference motion vector information that is output from the motion estimation section 40 as one piece of the information about inter prediction represents the difference motion vector MVDe. Then, the difference motion vector information may be encoded by the lossless encoding section 16, and transmitted to a device for decoding images.

### (1-3) Temporal Prediction

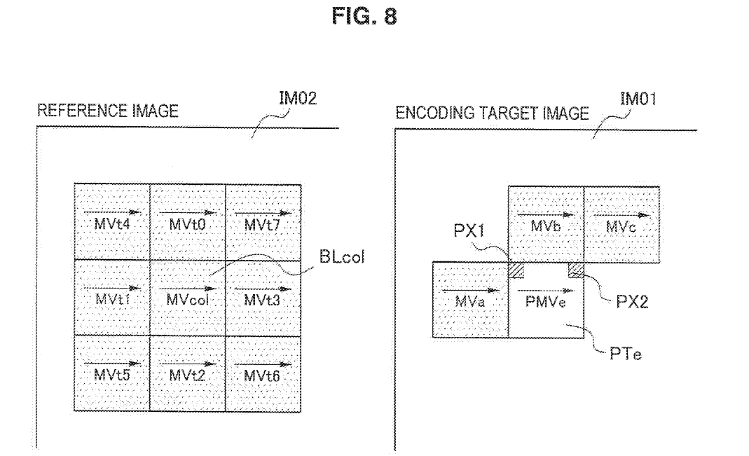

FIG. 8 is an explanatory diagram for describing temporal prediction in a rectangular partition. Referring to FIG. 8, an encoding target image IM01 including an encoding target partition PTe, and a reference image IM02 are shown. A block BLcol in the reference image IM02 is a so-called co-located block that includes a pixel at a common position, in the reference image IM02, as the reference pixel position PX1 or PX2. The prediction formula that uses temporal correlation of motion has, as an input, a motion vector set for the co-located block BLcol or a block (or a partition) adjacent to the co-located block BLcol.

For example, a motion vector MVcol set for the co-located block BLcol is taken as MVcol. Also, motion vectors set for blocks above, left, below, right, top left, bottom left, bottom right and top right of the co-located block BLcol are taken., respectively, as MVt0 to MVt7. These motion vectors MVcol and Mvt0 to MVt7 are already encoded. In this case, the predicted motion vector PMVe may be calculated from the motion vectors MVcol and MVt0 to MVt7 using the following prediction formula (3) or (4).

[Math. 3]

PMVe=med(MVcol, MVt1, . . . , MVt3) (3)

PMVe=med(MVcol, MVt1, . . . , MVt7) (4)

Also, a prediction formula as below that uses both the spatial correlation and the temporal correlation of motion may also be used. Additionally, the motion vectors MVa, MVb and MVc are motion vectors set for blocks adjacent to the reference pixel position. PX1 or PX2.

[Math. 4]

PMVe=med(MVcol,MVcol,MVa,MVb,MVc) (5)

Also in this case, the motion vector prediction section 45 calculates a difference motion vector MVDe representing a difference between a motion vector MVe calculated by the motion vector calculation section 42 and a predicted motion vector PMVe after deciding the predicted motion vector PMVe. Then, difference motion vector information representing a difference motion vector MVDe related to the optimal combination of a boundary and a prediction formula may be output from the motion estimation section 40 and encoded by the lossless encoding section 16.

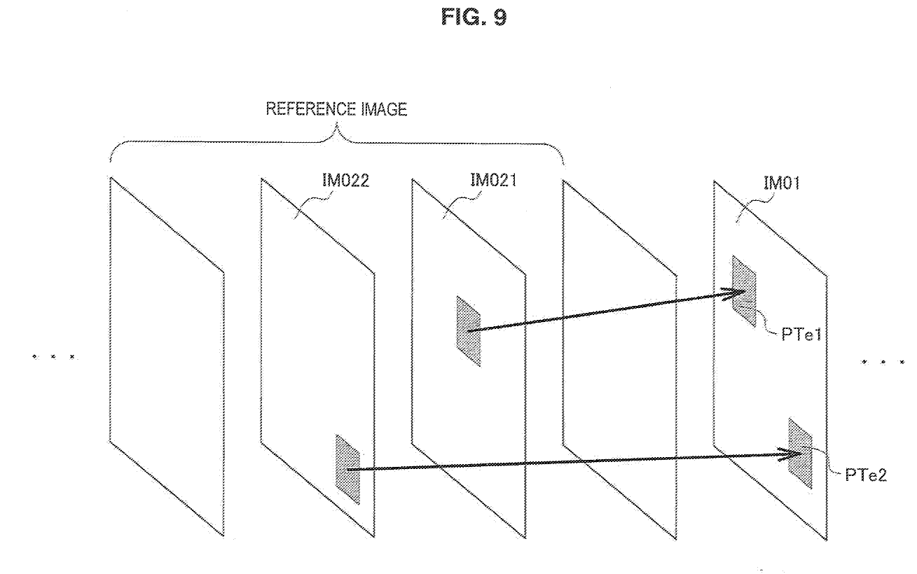

Additionally, in the example of FIG. 8, only one reference image IM02 is shown for one encoding target image IM01, but a different reference image may be used for each partition in one encoding target image IM01. In the example of FIG. 9, a reference image that is referred to at the time of prediction of a motion vector of a partition PTe1 in an encoding target image IM01 is IM021, and a reference image that is referred to at the time of prediction of a motion vector of a partition PTe2 is IM022. Such a method for setting a reference image is called a multi-reference frame.

### (2) Direct Mode

Additionally, to prevent lowering of the compression ratio in accordance with the increase in the amount of information of the motion vector information, H.264/AVC introduces a so-called direct mode mainly for a B picture. In the direct mode, the motion vector information is not encoded, and motion vector information of an encoding target block is generated from motion vector information of a block which is already encoded. The direct mode includes a spatial direct mode and a temporal direct mode, and it is possible to switch between these two modes depending on a slice, for example. Such direct mode may be used also in the present embodiment.

For example, in the spatial direct mode, a motion vector MVe for an encoding target partition may be decided using prediction formula (1) described above, in the manner of the following formula.

[Math. 5]

MVe=PMVe (6)

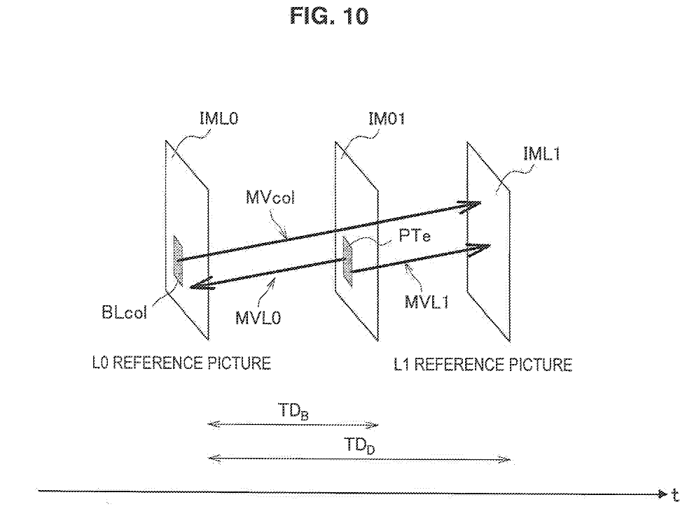

FIG. 10 is an explanatory diagram for describing the temporal direct mode. In FIG. 10, a reference image IML0 which is an L0 reference picture of an encoding target image IM01, and a reference image IML1 which is an L1 reference picture of the encoding target image IM01 are shown. A block BLcol in the reference image IML0 is a co-located block of an encoding target partition PTe in the encoding target image IM01. Here, a motion vector set for the co-located block BLcol is taken as MVcol. Also, a distance on a time axis between the encoding target image IM01 and the reference image IML0 is taken as TD_{B}, and a distance on a time axis between the reference image IML0 and the reference image IML1 is taken as TD_{D}. Then, in the temporal direct mode, motion vectors MVL0 and MVL1 for the encoding target partition PTe may be decided in the manner of the following formula.

$$\begin{matrix}[ Math . 6 ] & \\ MVL 0 = \frac{{TD}_{B}}{{TD}_{D}} MVcol & ( 7 ) \\ MVL 1 = \frac{{TD}_{D} - {TD}_{B}}{{TD}_{D}} MVcol & ( 8 )\end{matrix}$$

Additionally, as an index for expressing a distance on a time axis, a POC (Picture Order Count) may be used. The use/non-use of such direct mode may be specified on a block-by-block basis, for example.

### (3) Prediction of Motion Vector in Non-Rectangular Partition

As described above, reference pixel positions may be uniformly defined for rectangular partitions, in the manner of a pixel on the top left or the top right, for example. In contrast, in the case a block is partitioned by a boundary having an inclination as in the case of the geometry motion partition, since the shapes of non-rectangular partitions formed by partitioning are various, it is desirable that a reference pixel position is adaptively set.

### (3-1) Reference Pixel Position

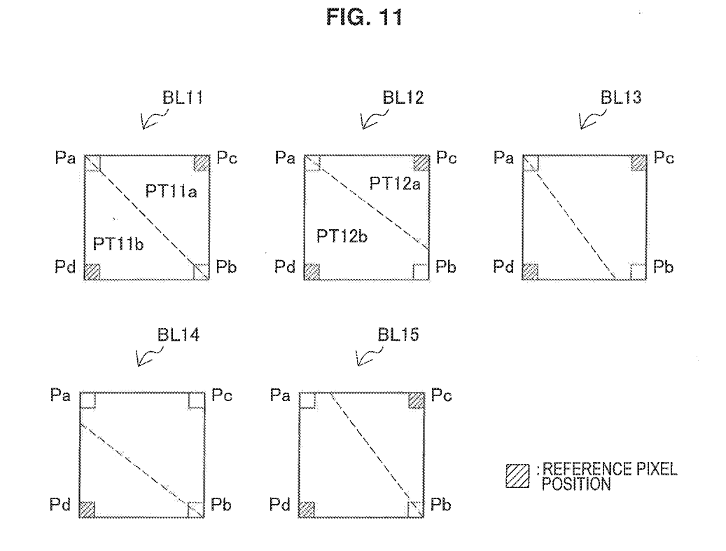

FIGS. 11 to 13 are explanatory diagrams for describing a reference pixel position which may be set in a non-rectangular partition. Five blocks BL11 to BL15 shown in FIG. 11 are blocks, among the ten blocks shown in FIG. 5, whose boundaries overlap one or both of a pixel Pa located at the top left corner and a pixel Pb located at the bottom right corner. If a boundary is a straight line, one of two partitions formed by partitioning in this case includes a pixel Pc located at the top right corner, and the other includes a pixel Pd located at the bottom left corner. Thus, in the case illustrated in FIG. 11, the reference pixel setting section 43 sets the reference pixel position of each partition to the position of the pixel Pc or the pixel Pd. In the example of FIG. 11, the reference pixel position of a partition PT11a of the block BL11 is set to the position of the pixel Pc. The reference pixel position of a partition PT11b of the block BL11 is set to the position of the pixel Pd. Likewise, the reference pixel position of a partition PT12a of the block BL12 is set to the position of the pixel Pc. The reference pixel position of a partition PT12b of the block BL12 is set to the position of the pixel Pd. Additionally, due to the symmetry of the shape of a block, the reference pixel setting section 43 may set the reference pixel position of each partition on the top left corner or the bottom right corner in the case the boundary overlaps at least one of the top right corner or the bottom left corner, for example.

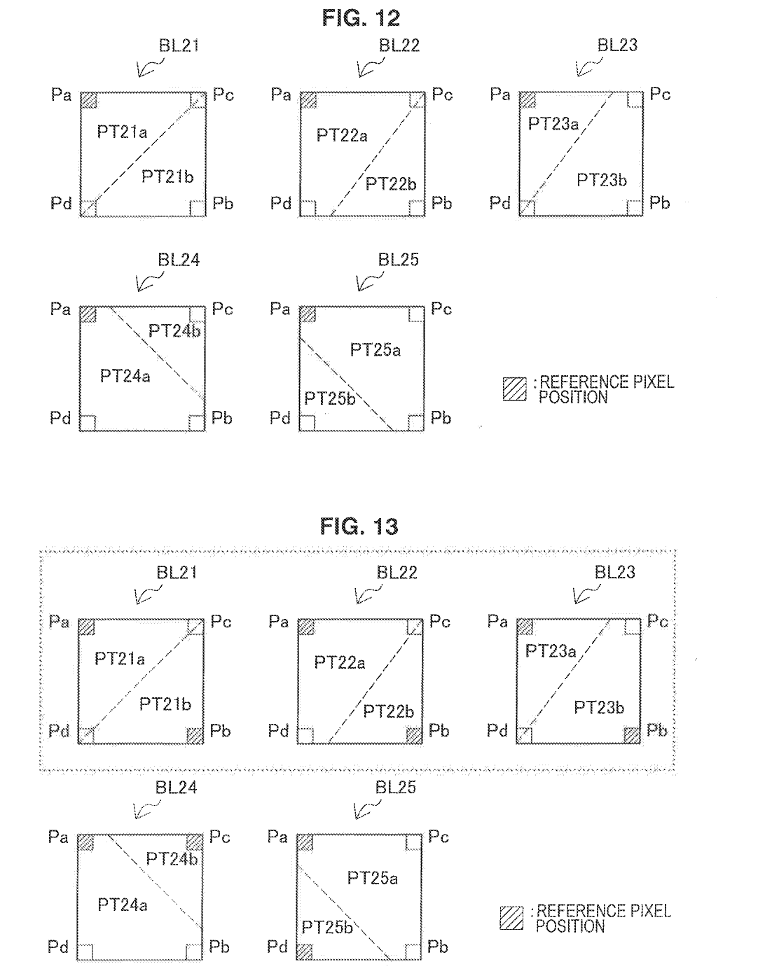

Five blocks BL21 to BL25 shown in FIG. 12 are blocks, among the ten blocks shown in FIG. 5, whose boundaries overlap neither of the top left corner and the bottom right corner. In this case, the reference pixel setting section 43 sets a reference pixel position of a first partition to which the top left corner belongs to the top left corner. In the example of FIG. 12, the reference pixel position of a partition PT21a of the block BL21 is set to the position of the pixel Pa. Likewise, the reference pixel positions of a partition PT22a of the block BL22, a partition PT23a of the block BL23, a partition PT24a of the block BL24, and a partition PT25a of the block BL25 are also set to the position of the pixel Pa.

Also, in the case a boundary overlaps neither of the top left corner and the bottom right corner, and the bottom right corner belongs to a second partition which is not the first partition to which the top left corner belongs, the reference pixel setting section 43 sets the reference pixel position of the second partition to the bottom right corner. Referring to FIG. 13, the reference pixel position of a partition PT21b of the block BL21 is set to the position of the pixel Pb. Likewise, the reference pixel positions of a partition PT22b of the block BL22 and a partition PT23b of the bock BL23 are also set to the position of the pixel Pb.

Furthermore, in the case the bottom right corner does not belong to the second partition, and the top right corner belongs to the second partition, the reference pixel setting section 43 sets the reference pixel position of the second partition to the top right corner. Referring to FIG. 13, the reference pixel position of a partition PT24b of the block BL24 is set to the position of the pixel Pc. Furthermore, for a case not corresponding to any of the cases above, the reference pixel setting section 43 sets the reference pixel position of the second partition to the bottom left corner. Referring to FIG. 13, the reference pixel position of a partition PT25b of the block BL25 is set to the position of the pixel Pd.

### (3-2) Spatial Prediction

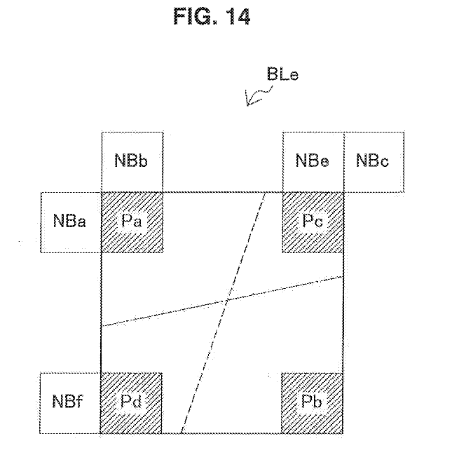

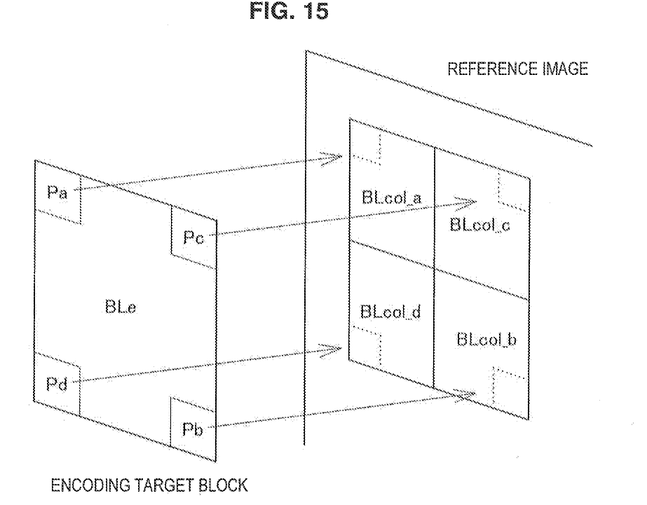

FIG. 14 is an explanatory diagram for describing spatial prediction in non-rectangular partitions as illustrated in FIGS. 11 to 13. Referring to FIG. 14, four pixel positions Pa to Pd which may be set as the reference pixel positions of respective partitions of an encoding target block BLe are shown. Also, blocks NBa and NBb are adjacent to the pixel position Pa. Blocks NBc and NBe are adjacent to the pixel position Pc. A block NBf is adjacent to the pixel position. Pd. A prediction formula that uses spatial correlation of motion in relation to a non-rectangular partition may be a prediction formula that takes, as inputs, motion vectors set for adjacent blocks (or partitions) NBa to NBf adjacent to the reference pixel positions Pa to Pd, for example.

Formulae (9) and (10) are each an example of a prediction formula for predicting a predicted motion vector PMVe for a partition whose reference pixel position is at the top left corner (the pixel position Pa). Additionally, a motion vector MVni (i=a, b, . . . , f) represents a motion vector set for an adjacent block NBi.

[Math. 7]

PMVe=MVna (9)

PMVe=MVnb (10)

Formulae (9) and (10) are examples of the simplest prediction formula. However, other formulae may also be used as the prediction formula. For example, in the case a partition includes both the top left and top right corners, a prediction formula based on motion vectors set for adjacent blocks NBa, NBb and NBc may be used, as with the spatial prediction for a rectangular partition described using FIG. 7. The prediction formula for this case is the same as formula (1).

Additionally; for a partition whose reference pixel position is at the bottom right corner (the pixel position Pb), a motion vector set for an adjacent block (or partition) cannot be used because the adjacent block is not yet encoded. In this case, the motion vector prediction section 45 may set the predicted motion vector based on the spatial correlation to a zero vector.

### (3-3) Temporal Prediction

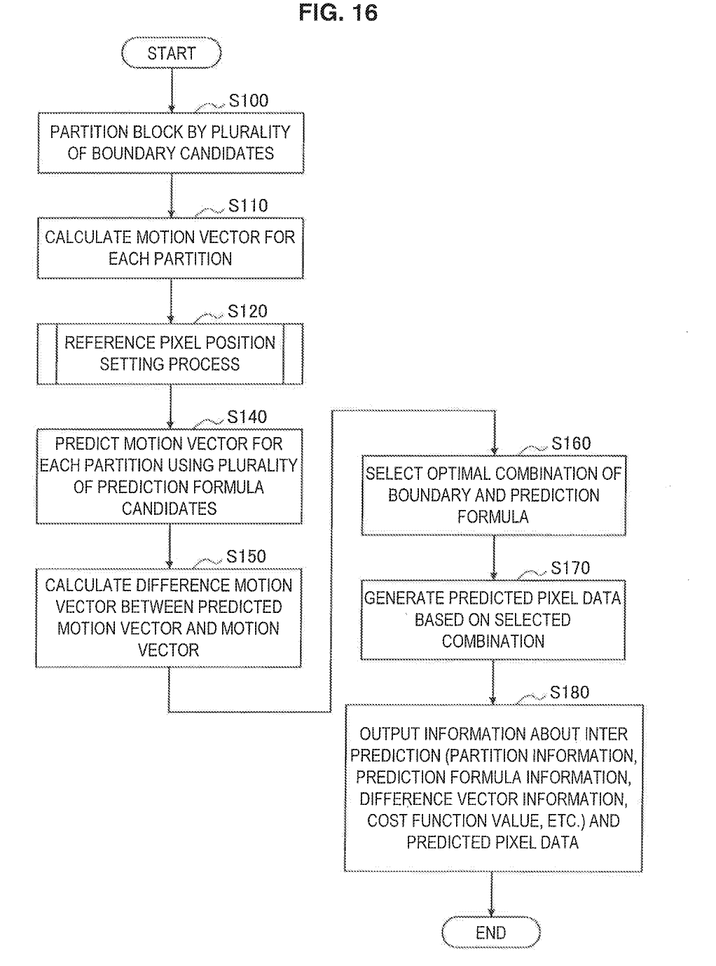

FIG. 15 is an explanatory diagram for describing temporal prediction in a non-rectangular partition. Referring to FIG. 15, four pixel positions Pa to Pd which may be set as reference pixel positions of respective partitions in an encoding target block BLe are shown. In the case the reference pixel position is the pixel position Pa, the co-located block in a reference image is a block Blcol_a. In the case the reference pixel position is the pixel position Pb, the co-located block in the reference image is a block BLcol_b. In the case the reference pixel position is the pixel position Pc, the co-located block in the reference image is a block BLcol_c. In the case the reference pixel position is the pixel position Pd, the co-located block in the reference image is a block BLcol_d. The motion vector prediction section 45 recognizes a co-located block (or a co-located partition) BLcol in this manner according to a reference pixel position set by the reference pixel setting section 43. Also, as described using FIG. 8, the motion vector prediction section 45 further recognizes a block or a partition adjacent to the co-located block (or the co-located partition) BLcol, for example. Then, the motion vector prediction section 45 can calculate a predicted motion vector using the motion vectors MYcol and MVt0 to MVt7 (see FIG. 8) set in the blocks or the partitions in the reference image corresponding to the reference pixel positions and according to the prediction formula that uses temporal correlation of motion. The prediction formula for this case may be the same as the formula (3) or (4), for example.

### (3-4) Temporal/Spatial Prediction

Furthermore, the motion vector prediction section 45 may use a prediction formula that uses both the spatial correlation and the temporal correlation of motion, also for a non-rectangular partition. In such a case, the motion vector prediction section 45 can use a prediction formula that is based on a motion vector set for an adjacent block (or an adjacent partition) described using FIG. 14 and a motion vector set for a co-located block (or a co-located partition) in a reference image described using FIG. 15. The prediction formula for this case may be the same as formula (5), for example.

### (4) Selection of Prediction Formula

As described above, the motion vector prediction section 45 may use as the prediction formula candidates, at the time of prediction of a motion vector (calculation of a predicted motion vector), a prediction formula that uses spatial correlation, a prediction formula that uses temporal correlation, and a prediction formula that uses temporal/spatial correlation. Also, the motion vector prediction section 45 may use a plurality of prediction formula candidates as the prediction formula that uses temporal correlation, for example. The motion vector prediction section 45 calculates a predicted motion vector for each partition in this manner for each of a plurality of boundary candidates set by the partitioning section 41 and for each of a plurality of prediction formula candidates. Then, the selection section 46 evaluates each combination of a boundary candidate and a prediction formula candidate based on a cost function value, and selects an optimal combination with the highest compression ratio (that achieves the highest encoding efficiency). As a result, a boundary that partitions a block is changed for each block set in an image, for example, and a prediction formula applied to a block can be adaptively switched.

### 2. FLOW OF PROCESS AT THE TIME OF ENCODING ACCORDING TO AN EMBODIMENT

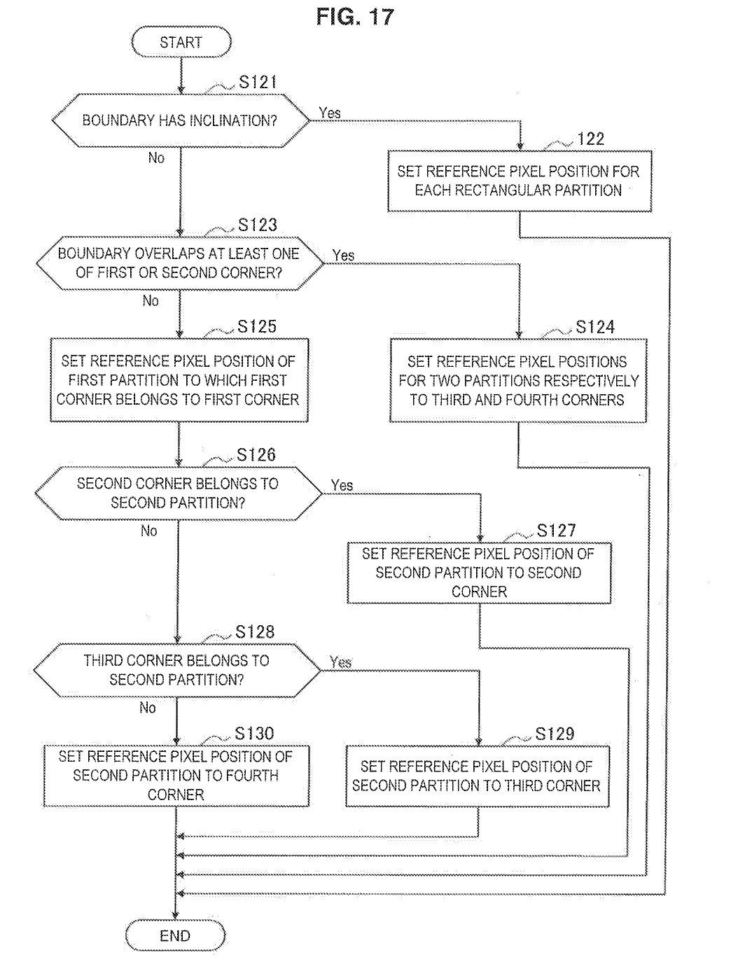

Next, flows of processes at the time of encoding will be described using FIGS. 16 and 17.

### 2-1. Motion Estimation Process

FIG. 16 is a flow chart showing an example of a flow of a motion estimation process of the motion estimation section 40 according to the present embodiment.

Referring to FIG. 16, first, the partitioning section 41 partitions a block set in an image into a plurality of partitions by a plurality of boundary candidates including a boundary having an inclination (step S100). For example, a first boundary candidate is a boundary along a horizontal direction or a vertical direction according to H.264/AVC, and each block may be partitioned into a plurality of rectangular partitions by the first boundary candidate. Also, a second boundary candidate is a boundary having an inclination (a sloping boundary) according to the geometry motion partitioning, and each block may be partitioned into a plurality of non-rectangular partitions by the second boundary candidate.

Next, the motion vector calculation section 42 calculates a motion vector for each partition based on a pixel value of a reference image and a pixel value of an original image in each partition (step S110).

Next, the reference pixel setting section 44 sets a reference pixel position in each partition according to the inclination of a boundary which has partitioned a block (step S120). Additionally, the flow of a reference pixel position setting process of the reference pixel setting section 44 will be described later in detail.

Next, the motion vector prediction section 45 predicts, for each partition, a motion vector to be used for prediction of a pixel value in each partition of the block partitioned by the partitioning section 41, using a plurality of prediction formula candidates (step S140). For example, a first prediction formula candidate is the prediction formula that uses spatial correlation described above. A second prediction formula candidate is the prediction formula that uses temporal correlation described above. A third prediction formula candidate is the prediction formula that uses both the spatial correlation and the temporal correlation described above. Here, to use the prediction formula that uses temporal correlation, for example, it is important that a block or a partition, in a reference image, which is at the same position (that is, co-located) as an encoding target partition can be identified. In the present embodiment, the motion vector prediction section 45 may identify a co-located block or partition based on a reference pixel position that changes according to the inclination of a boundary. Accordingly, prediction of a motion vector using temporal correlation of motion is possible even in a case where a partitioning method such as the geometry motion partitioning according to which partitions of various shapes may be formed by partitioning is used, for example.

Next, the motion vector prediction section 45 calculates, for each combination of a boundary and a prediction formula as candidates, a difference motion vector representing a difference between a motion vector calculated by the motion vector calculation section 42 and a predicted motion vector (step S150).

Next, based on the prediction results of the motion vector prediction section 45, the selection section 46 evaluates a cost function value for each combination of a boundary and a prediction formula, and selects a combination of a boundary and a prediction formula that achieves the highest encoding efficiency (step S160). A cost function used by the selection section 46 may he a function that is based on differential energy between an original image and a decoded image, and an occurring bit rate.

Next, using the optimal boundary and the optimal prediction formula selected by the selection section 46, the motion compensation section 47 calculates a predicted pixel value related to a pixel in an encoding target block and generates predicted image data (step S170).

Then, the motion compensation section 47 outputs information about inter prediction and the predicted pixel data to the mode selection section 50 (step S180). The information about inter prediction may include partition information identifying the optimal boundary, prediction formula information identifying the optimal prediction formula, corresponding difference motion vector information, reference image information, a corresponding cost function value, and the like for example. Additionally, a motion vector that is finally set for each partition in each block is stored by the motion vector buffer 44 as a reference motion vector.

### 2-2. Reference Pixel Position Setting Process

FIG. 17 is a flow chart showing an example of a flow of the reference pixel position setting process, corresponding to the process of step S120 in FIG. 16, according to the present embodiment.

Referring to FIG. 17, first, the reference pixel setting section 43 determines whether or not a boundary, as a candidate, for partitioning a block has an inclination (step S121). For example, in the case the boundary is horizontal or vertical, the reference pixel setting section 43 determines that the boundary does not have an inclination. In this case, the process proceeds to step S122. Also, in the case the boundary is not horizontal or vertical, the reference pixel setting section 43 determines that the boundary has an inclination. In this case, the process proceeds to step S123.

In step S122, the reference pixel setting section 43 sets the top left corner of the top right corner of each partition as a reference pixel position in the manner of the example of an existing image encoding method such as H.264/AVC as illustrated in FIG. 6 (step S122).

In the case the process proceeds to step S123, each partition is a non-rectangular partition. In this case, the reference pixel setting section 43 determines whether or not the boundary, as a candidate, for partitioning the block overlaps at least one of a first corner or a second corner of the block, the first and second corners being located opposite each other (step S123). The positions of the first corner and the second corner correspond, for example, to the pixel positions Pa and Pb illustrated in FIG. 11, respectively. Alternatively, the positions of the first corner and the second corner may be the pixel positions Pc and Pd illustrated in FIG. 11, for example. Additionally, in the present specification, the expression “overlap a corner” includes not only a case where a boundary passes through a vertex of a block, but also a case where a boundary passes through a pixel located at a corner of a block.

In the case the boundary is determined in step S123 to overlap at least one of the first or second corner, the reference pixel setting section 43 sets the reference pixel positions of two partitions respectively to a third corner and a fourth corner different from the first corner and the second corner as illustrated in FIG. 11 (step S124).

In the case the boundary is determined in step S123 to overlap neither of the first and the second corners, the reference pixel setting section 43 sets the reference pixel position of a first partition to which the first corner belongs to the first corner as illustrated in FIG. 12 (step S125).

Next, the reference pixel setting section 43 determines whether or not the second corner belongs to a second partition to which the first corner does not belong (step S126).

In the case the second corner is determined in step S126 to belong to the second partition to which the first corner does not belong, the reference pixel setting section 43 sets the reference pixel position of the second partition to the second corner, as in the examples of blocks BL21 to BL23 in FIG. 13 (step S127).

In the case the second corner is determined in step S126 to not belong to the second partition to which the first corner does not belong, the reference pixel setting section 43 further determines whether or not the third corner belongs to the second partition (step S128).

In the case the third corner is determined in step S128 to belong to the second partition, the reference pixel setting section 43 sets the reference pixel position of the second partition to the third corner (step S129).

In the case the third corner is determined in step S128 to not belong to the second partition, the reference pixel setting section 43 sets the reference pixel position of the second partition to the fourth corner (step S130).

A reference pixel position can be adaptively set for each partition by such reference pixel position setting process even in a case where partitions which are the units of processing of motion compensation may take various shapes other than a rectangle, as with the geometry motion partitioning.

### 3. EXAMPLE CONFIGURATION OF IMAGE DECODING DEVICE ACCORDING TO AN EMBODIMENT

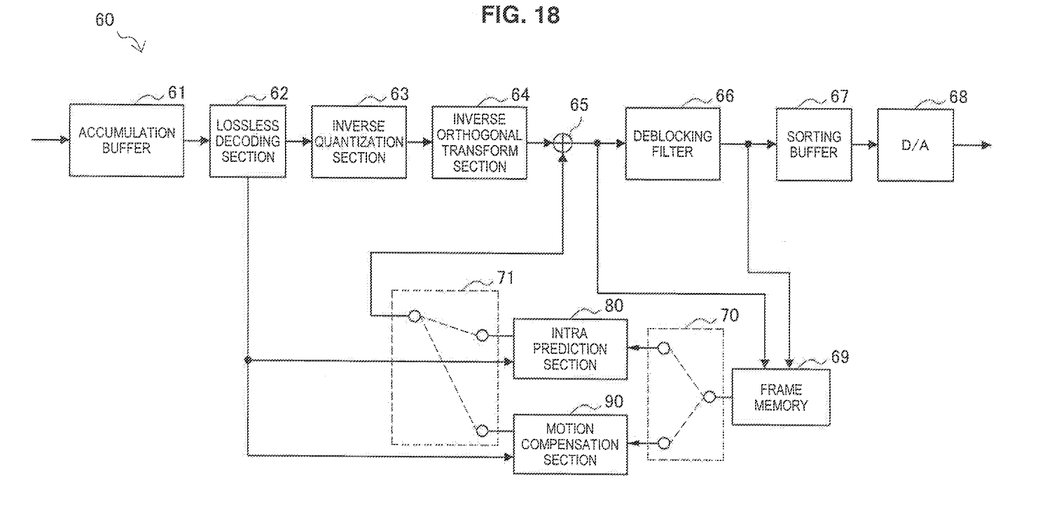

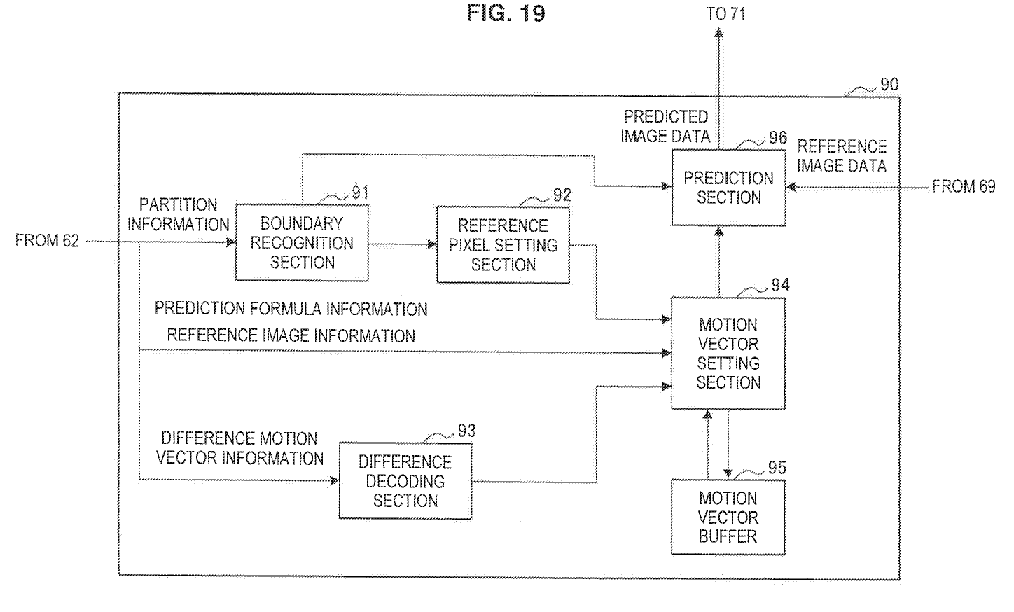

In this section, an example configuration of an image decoding device according to an embodiment will be described using FIGS. 18 and 19.

### 3-1. Example of Overall Configuration

FIG. 18 is a block diagram showing an example of a configuration of an image decoding device 60 according to an embodiment. Referring to FIG. 18, the image decoding device 60 includes an accumulation buffer 61, a lossless decoding section 62, an inverse quantization section 63, an inverse orthogonal transform section 64, an addition section 65, a deblocking filter 66, a sorting, buffer 67, a D/A (Digital to Analogue) conversion section 68, a frame memory 69, selectors 70 and 71, an intra prediction section 80, and a motion compensation section 90.

The accumulation buffer 61 temporarily stores an encoded stream input via a transmission line using a storage medium.

The lossless decoding section 62 decodes an encoded stream input from the accumulation buffer 61 according to the encoding method used at the time of encoding. Also, the lossless decoding section 62 decodes information multiplexed to the header region of the encoded stream information that is multiplexed to the header region of the encoded stream may include information about intra prediction and information about inter prediction in the block header, for example. The lossless decoding section 62 outputs the information about intra prediction to the intra prediction section 80. Also, the lossless decoding section 62 outputs the information about inter prediction to the motion compensation section 90.

The inverse quantization section 63 inversely quantizes quantized data which has been decoded by the lossless decoding section 62. The inverse orthogonal transform section 64 generates predicted error data by performing inverse orthogonal transformation on transform coefficient data input from the inverse quantization section 63 according to the orthogonal transformation method used at the time of encoding. Then, the inverse orthogonal transform section 64 outputs the generated predicted error data to the addition section 65.

The addition section 65 adds the predicted error data input from the inverse orthogonal transform section 64 and predicted image data input from the selector 71 to thereby generate decoded image data. Then, the addition section 65 outputs the generated decoded image data to the deblocking filter 66 and the frame memory 69.

The deblocking filter 66 removes block distortion by filtering the decoded image data input from the addition section 65, and outputs the decoded image data after filtering to the sorting buffer 67 and the frame memory 69.

The sorting buffer 67 generates a series of image data in a time sequence by sorting images input from the deblocking filter 66. Then, the sorting buffer 67 outputs the generated image data to the D/A conversion section 68.

The D/A conversion section 68 converts the image data in a digital format input from the sorting buffer 67 into an image signal in an analogue format. Then, the D/A conversion section 68 causes an image to be displayed by outputting the analogue image signal to a display (not shown) connected to the image decoding device 60, for example.

The frame memory 69 stores, using a storage medium, the decoded image data before filtering input from the addition section 65, and the decoded image data after filtering input from the deblocking filter 66.

The selector 70 switches the output destination of the image data from the frame memory 69 between the intra prediction section 80 and the motion compensation section 90 for each block in the image according to mode information acquired by the lossless decoding section 62. For example, in the case the intra prediction mode is specified, the selector 70 outputs the decoded image data before filtering that is supplied from the frame memory 69 to the intra prediction section 80 as reference image data. Also, in the case the inter prediction mode is specified, the selector 70 outputs the decoded image data after filtering that is supplied from the frame memory 69 to the motion compensation section 90 as the reference image data.

The selector 71 switches the output source of predicted image data to be supplied to the addition section 65 between the intra prediction section 80 and the motion compensation section 90 for each block in the image according to the mode information acquired by the lossless decoding section 62. For example, in the case the intra prediction mode is specified, the selector 71 supplies to the addition section 65 the predicted image data output from the intra prediction section 80. In the case the inter prediction mode is specified, the selector 71 supplies to the addition section 65 the predicted image data output from the motion compensation section 90.

The intra prediction section 80 performs in-screen prediction of a pixel value based on the information about intra prediction input from the lossless decoding section 62 and the reference image data from the frame memory 69, and generates predicted image data. Then, the intra prediction section 80 outputs the generated predicted image data to the selector 71.

The motion compensation section 90 performs a motion compensation process based on the information about inter prediction input from the lossless decoding section 62 and the reference image data from the frame memory 69, and generates predicted image data. Then, the motion compensation section 90 outputs the generated predicted image data to the selector 71.

### 3-2. Example Configuration of Motion Compensation Section

FIG. 19 is a block diagram showing an example of a detailed configuration of the motion compensation section 90 of the image decoding device 60 shown in FIG. 18. Referring to FIG. 19, the motion compensation section 90 includes a boundary recognition section 91, a reference pixel setting section 92, a difference decoding section 93, a motion vector setting section 94, a motion vector buffer 95, and a prediction section 96.

The boundary recognition section 91 recognizes the inclination of a boundary that has partitioned a block in an image at the time of encoding of the image. Such a boundary is a boundary that is selected from a plurality of candidates including a boundary having an inclination. More specifically, the boundary recognition section 91 first acquires partition information included in the information about inter prediction that is input from the lossless decoding section 62. The partition information is information for identifying a boundary that is determined to be optimal at the image encoding device 10 from the standpoint of compression ratio, for example. As described above, the partition information may include the partitioning mode information that specifies either the rectangular partitioning or the geometry motion partitioning, and a boundary parameter that specifies the position and the inclination of a boundary (for example, the distance p and the inclination angle θ described above). Then, the boundary recognition section 91 refers to the partition information acquired, and recognizes the inclination of the boundary which has partitioned each block.

The reference pixel setting section 92 sets a reference pixel position in each partition in a block according to the inclination of the boundary recognized by the boundary recognition section 91. The reference pixel position setting process of the reference pixel setting section 92 may be the same as the process of the reference pixel setting section 43 of the it encoding device 10 illustrated in FIG. 17. Then, the reference pixel setting section 92 notifies the motion vector setting section 94 of the reference pixel position which has been set.

The difference decoding section 93 decodes a difference motion vector calculated at the time of encoding for each partition, based on difference motion vector information included in the information about inter prediction input from the lossless decoding section 62. Then, the difference decoding section 93 outputs the difference motion vector to the motion vector setting section 94.

The motion vector setting section 94 sets a motion vector to be used for prediction of a pixel value in each partition in a block which has been partitioned, based on a motion vector set for a block or a partition corresponding to the reference pixel position set by the reference pixel setting section 92. More specifically, the motion vector setting section 94 first acquires prediction formula information included in the information about inter prediction input from the lossless decoding section 62. The prediction formula information may be acquired in association with each partition. The prediction formula information identifies a prediction formula selected at the time of encoding, from a prediction formula that uses spatial correlation, a prediction formula that uses temporal correlation, and a prediction formula that uses both the spatial correlation and the temporal correlation, for example. Next, the motion vector setting section 94 acquires, as a reference motion vector, a motion vector set for an already encoded block or partition in an encoding target image or the reference image corresponding to the reference pixel position set by the reference pixel setting section 92. Then, the motion vector setting section 94 substitutes the reference motion vector in the prediction formula identified by the prediction formula information, and calculates a predicted motion vector. Furthermore, the motion vector setting section 94 calculates a motion vector by adding the difference motion vector input from the difference decoding section 93 to the calculated predicted motion vector. The motion vector setting section 94 sets the motion vector calculated in this manner for each partition. Also, the motion vector setting section 94 outputs the motion vector set for each partition to the motion vector buffer 95.

The motion vector buffer 95 temporarily stores a motion vector which is referred to in the motion vector setting process of the motion vector setting section 94 using a storage medium. A motion vector which is referred to at the motion vector buffer 95 may include a motion vector set for a block or a partition in an already decoded reference image, and a motion vector set for another block or partition in the encoding target image.

The prediction section 96 generates a predicted pixel value for each partition in a block which has been partitioned by the boundary recognized by the boundary recognition section 91, using the motion vector set by the motion vector setting section 94 and the reference image information, and the reference image data input from the frame memory 69. Then, the prediction section 93 outputs predicted image data including the generated predicted pixel value to the selector 71.

### 4. FLOW OF PROCESS AT THE TIME OF DECODING ACCORDING TO AN EMBODIMENT

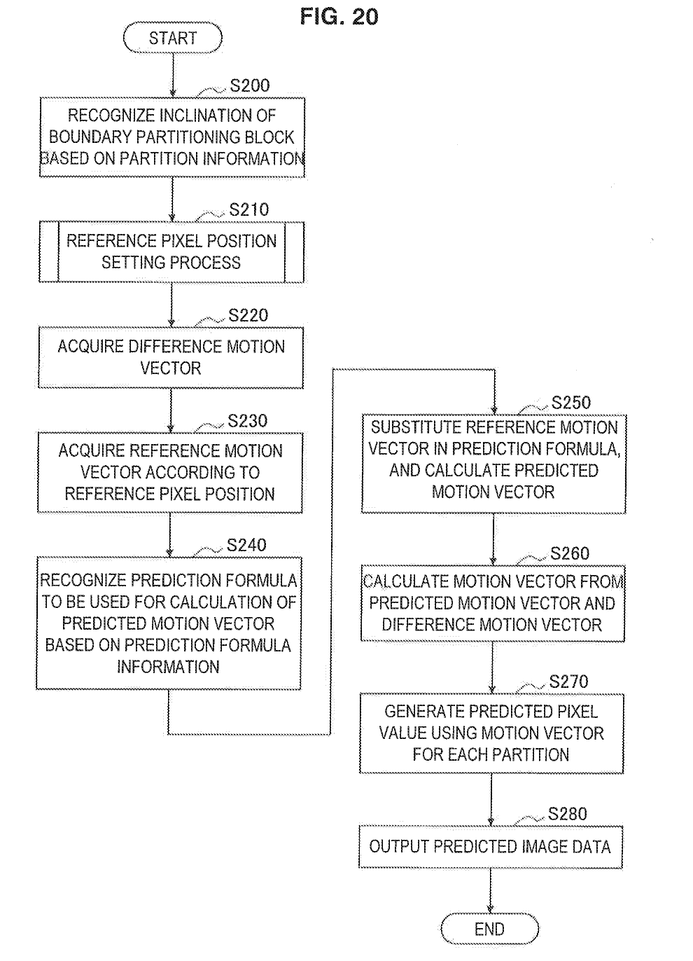

Next, a flow of a process at the time of decoding will be described using FIG. 20. FIG. 20 is a flow chart showing an example of a flow of the motion compensation process of the motion compensation section 90 of the image decoding device 60 according to the present embodiment.

Referring to FIG. 20, first, the boundary recognition section 91 of the image encoding device 60 recognizes the inclination of a boundary that has partitioned a block in an image at the time of encoding of the image, based on partition information included in information about inter prediction input from the lossless decoding section 62 (step S200).

Next, the reference pixel setting section 92 sets a reference pixel position for each partition according to the inclination of the boundary recognized by the boundary recognition section 91 (step S210). Additionally, the flow of the reference pixel position setting process of the reference pixel setting section 92 may be the same as the process of the reference pixel setting section 43 of the image encoding device 10 illustrated in FIG. 17.

Next, the difference decoding section 93 acquires a difference motion vector based on difference motion vector information included in the information about inter prediction input from the lossless decoding section 62 (step S220). Then, the difference decoding section 93 outputs the acquired difference motion vector to the motion vector setting section 94.

Next, the motion vector setting section 94 acquires from the motion vector buffer 95 a reference motion vector, which is a motion vector set for a block or a partition corresponding to the reference pixel position set by the reference pixel setting section 92 (step S230).

Next, the motion vector setting section 94 recognizes a prediction formula to be used for calculation of a predicted motion vector based on prediction formula information included in the information about inter prediction input from the lossless decoding section 62 (step S240).

Next, the motion vector setting section 94 calculates a predicted motion vector for each partition by substituting the reference motion vector in the prediction formula recognized based on the prediction formula information (step S250).

Next, the motion vector setting section 94 calculates a motion vector for each partition by adding the difference motion vector input from the difference decoding section 93 to the calculated predicted motion vector (step S260). The motion vector setting section 94 calculates a motion vector for each partition in this manner, and sets the calculated motion vector to each partition.

Next, the prediction section 94 generates a predicted pixel value using the motion vector set by the motion vector setting section 94, reference image information, and reference image data input from the frame memory 69 (step S270).

Next, the prediction section 94 outputs predicted image data including the generated predicted pixel value to the selector 71 (step S280).

### 5. EXAMPLE APPLICATION

The image encoding device 10 and the image decoding device 60 according to the embodiment described above may be applied to various electronic appliances such as a transmitter and a receiver for satellite broadcasting, cable broadcasting such as cable TV, distribution on the Internet, distribution to terminals via cellular communication, and the like, a recording device that records images in a medium such as an optical disc, a magnetic disk or a flash memory, a reproduction device that reproduces images from such storage medium, and the like. Four example applications will be described below.

### 5-1. First Example Application

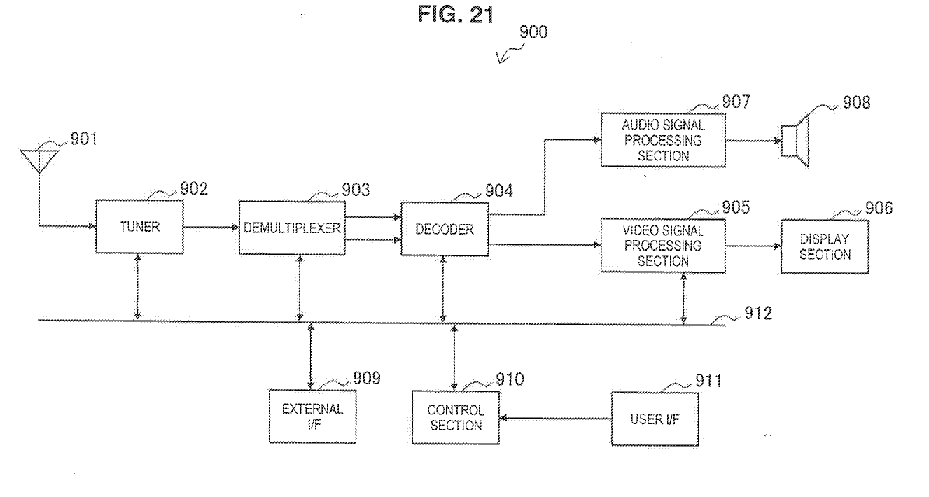

FIG. 21 is a block diagram showing an example of a schematic configuration of a television adopting the embodiment described above. A television 900 includes an antenna 901, a timer 902, a demultiplexer 903, a decoder 904, an video signal processing section 905, a display section 906, an audio signal processing section 907, a speaker 908, an external interface 909, a control section 910, a user interface 911, and a bus 912.

The tuner 902 extracts a signal of a desired channel from broadcast signals received via the antenna 901, and demodulates the extracted signal. Then, the tuner 902 outputs an encoded bit stream obtained by demodulation to the demultiplexer 903. That is, the tuner 902 serves as transmission means of the televisions 900 for receiving an encoded stream in which an image is encoded.

The demultiplexer 903 separates a video stream and an audio stream of a program to be viewed from the encoded bit stream, and outputs each stream which has been separated to the decoder 904. Also, the demultiplexer 903 extracts auxiliary data such as an EPG (Electronic Program Guide) from the encoded bit stream, and supplies the extracted data to the control section 910. Additionally, the demultiplexer 903 may perform descrambling in the case the encoded bit stream is scrambled.

The decoder 904 decodes the video stream and the audio stream input from the demultiplexer 903. Then, the decoder 904 outputs video data generated by the decoding process to the video signal processing section 905. Also, the decoder 904 outputs the audio data generated by the decoding process to the audio signal processing section 907.

The video signal processing section 905 reproduces the video data input from the decoder 904, and causes the display section 906 to display the video. The video signal processing section 905 may also cause the display section 906 to display an application screen supplied via a network. Further, the video signal processing section 905 may perform an additional process such as noise removal, for example, on the video data according to the setting. Furthermore, the video signal processing section 905 may generate an image of a GUI (Graphical User Interface) such as a menu, a button, a cursor or the like, for example, and superimpose the generated image on an output image.

The display section 906 is driven by a drive signal supplied by the video signal processing section 905, and displays a video or an image on an video screen of a display device (for example, a liquid crystal display, a plasma display, an OLED, or the like).

The audio signal processing section 907 performs reproduction processes such as D/A conversion and amplification on the audio data input from the decoder 904, and outputs audio from the speaker 908. Also, the audio signal processing section 907 may perform an additional process such as noise removal on the audio data.

The external interface 909 is an interface for connecting the television 900 and an external appliance or a network. For example, a video stream or an audio stream received via the external interface 909 may be decoded by the decoder 904. That is, the external interface 909 also serves as transmission means of the televisions 900 for receiving an encoded stream in which an image is encoded.

The control section 910 includes a processor such as a CPU (Central Processing Unit), and a memory such as an RAM (Random Access Memory), an ROM (Read Only Memory), or the like. The memory stores a program to be executed by the CPU, program data, EPG data, data acquired via a network, and the like. The program stored in the memory is read and executed by the CPU at the time of activation of the television 900, for example. The CPU controls the operation of the television 900 according to an operation signal input from the user interface 911, for example, by executing the program.

The user interface 911 is connected to the control section 910. The user interface 911 includes a button and a switch used by a user to operate the television 900, and a receiving section for a remote control signal, for example. The user interface 911 detects an operation of a user via these structural elements, generates an operation signal, and outputs the generated operation signal to the control section 910.

The bus 912 interconnects the tuner 902, the demultiplexer 903, the decoder 904, the video signal processing section 905, the audio signal processing section 907, the external interface 909, and the control section 910.

In the television 900 configured in this manner, the decoder 904 has a function of the image decoding device 60 according to the embodiment described above. Accordingly, also in the case a block is partitioned in the television 900 by a partitioning method allowing various shapes other than a rectangle, the compression ratio can be increased and the image quality after decoding can be enhanced by adaptively setting a reference pixel position and predicting a motion vector.

### 5-2. Second Example Application

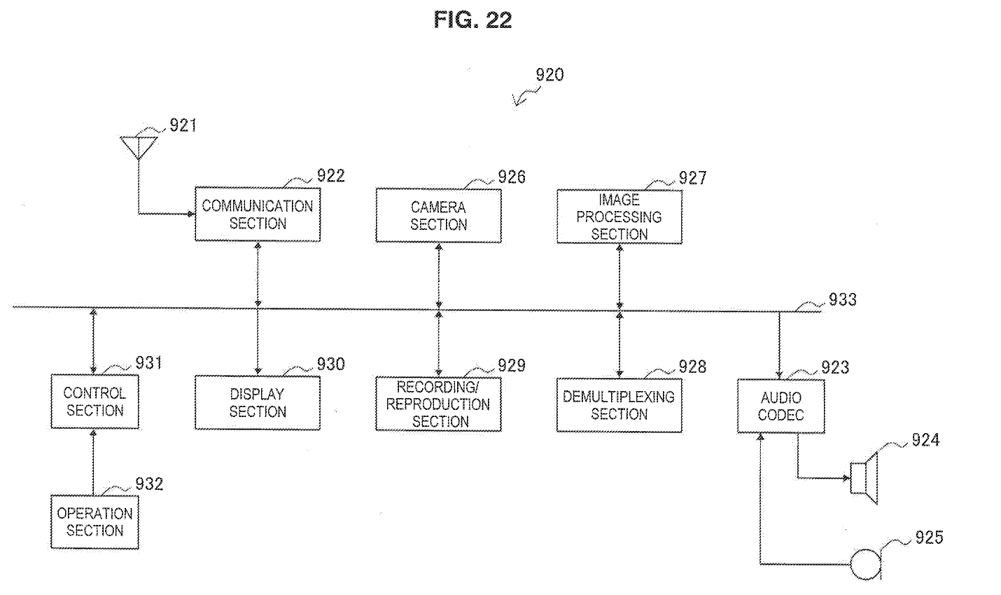

FIG. 22 is a block diagram showing an example of a schematic configuration of a mobile phone adopting the embodiment described above. A mobile phone 920 includes an antenna 921, a communication section 922, an audio codec 923, a speaker 924, a microphone 925, a camera section 926, an image processing section 927, a demultiplexing section 928, a recording/reproduction section 929, a display section 930, a control section 931, an operation section 932, and a bus 933.

The antenna 921 is connected to the communication section 922. The speaker 924 and the microphone 925 are connected to the audio codec 923. The operation section 932 is connected to the control section 931. The bus 933 interconnects the communication section 922, the audio codec 923, the camera section 926, the image processing section 927, the demultiplexing section 928, the recording/reproduction section 929, the display section 930, and the control section 931.

The mobile phone 920 performs operation such as transmission/reception of audio signal, transmission/reception of entails or image data, image capturing, recording of data, and the like, in various operation modes including an audio communication mode, a data communication mode, an image capturing mode, and a videophone mode.

In the audio communication mode, an analogue audio signal generated by the microphone 925 is supplied to the audio codec 923. The audio codec 923 converts the analogue audio signal into audio data, and A/D converts and compresses the converted audio data. Then, the audio codec 923 outputs the compressed audio data to the communication section 922. The communication section 922 encodes and modulates the audio data, and generates a transmission signal. Then, the communication section 922 transmits the generated transmission signal to a base station (not shown) via the antenna 921. Also, the communication section 922 amplifies a wireless signal received via the antenna 921 and converts the frequency of the wireless signal, and acquires a received signal. Then, the communication section 922 demodulates and decodes the received signal and generates audio data, and outputs the generated audio data to the audio codec 923. The audio codec 923 extends and D/A converts the audio data, and generates an analogue audio signal. Then, the audio codec 923 supplies the generated audio signal to the speaker 924 and causes the audio to be output.

Also, in the data communication mode, the control section 931 generates text data that makes up an email, according to an operation of a user via the operation section 932, for example. Moreover, the control section 931 causes the text to be displayed on the display section 930. Furthermore, the control section 931 generates email data according to a transmission instruction of the user via the operation section 932, and outputs the generated email data to the communication section 922. Then, the communication section 922 encodes and modulates the email data, and generates a transmission signal. Then, the communication section 922 transmits the generated transmission signal to a base station (not shown) via the antenna 921. Also, the communication section 922 amplifies a wireless signal received via the antenna 921 and converts the frequency of the wireless signal, and acquires a received signal. Then, the communication section 922 demodulates and decodes the received signal, restores the email data, and outputs the restored email data to the control section 931. The control section 931 causes the display section 930 to display the contents of the email, and also, causes the email data to be stored in the storage medium of the recording/reproduction section 929.

The recording/reproduction section 929 includes an arbitrary readable and writable storage medium. For example, the storage medium may be a built-in storage medium such as an RAM, a flash memory or the like, or an externally mounted storage medium such as a hard disk, a magnetic disk, a magneto-optical disk, an optical disc, an USB memory, a memory card, or the like.

Furthermore, in the image capturing mode, the camera section 926 captures an image of a subject, generates image data, and outputs the generated image data to the image processing section 927, for example. The image processing section 927 encodes the image data input from the camera section 926, and causes the encoded stream to be stored in the storage medium of the recording/reproduction section 929.

Furthermore, in the videophone mode, the demultiplexing section 928 multiplexes a video stream encoded by the image processing section 927 and an audio stream input from the audio codec 923, and outputs the multiplexed stream to the communication section 922, for example. The communication section 922 encodes and modulates the stream, and generates a transmission signal. Then, the communication section 922 transmits the generated transmission signal to a base station (not shown) via the antenna 921. Also, the communication section 922 amplifies a wireless signal received via the antenna 921 and converts the frequency of the wireless signal, and acquires a received signal. These transmission signal and received signal may include an encoded bit stream. Then, the communication section 922 demodulates and decodes the received signal, restores the stream, and outputs the restored stream to the demultiplexing section 928. The demultiplexing section 928 separates a video stream and an audio stream from the input stream, and outputs the video stream to the image processing section 927 and the audio stream to the audio codec 923. The image processing section 927 decodes the video stream, and generates video data. The video data is supplied to the display section 930, and a series of images is displayed by the display section 930. The audio codec 923 extends and D/A converts the audio stream, and generates an analogue audio signal. Then, the audio codec 923 supplies the generated audio signal to the speaker 924 and causes the audio to be output.

In the mobile phone 920 configured in this manner, the image processing section 927 has a function of the image encoding device 10 and the image decoding device 60 according to the embodiment described above. Accordingly, also in the case a block is partitioned in the mobile phone 920 by a partitioning method allowing various shapes other than a rectangle, the compression ratio can be increased and the image quality after decoding can be enhanced by adaptively setting a reference pixel position and predicting a motion vector.

### 5-3. Third Example Application

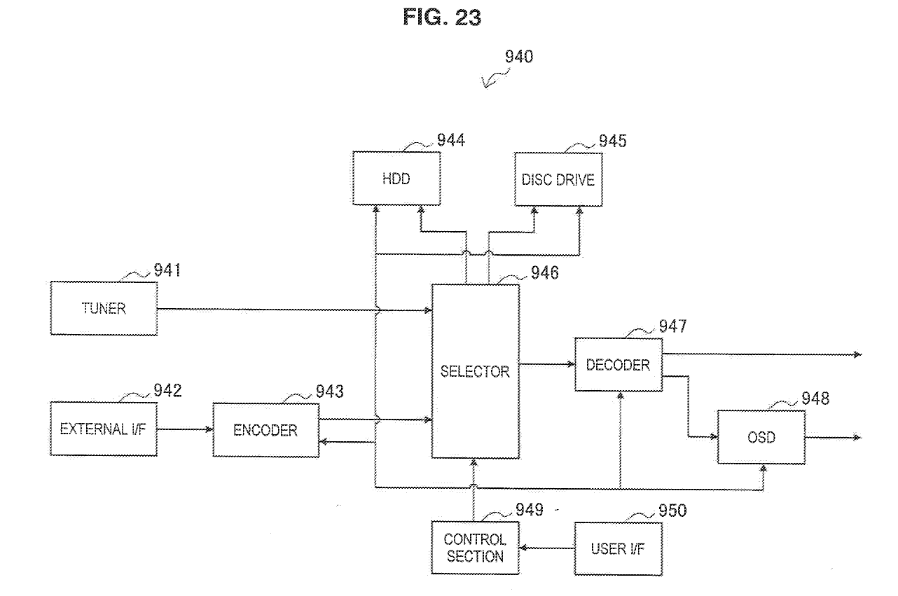

FIG. 23 is a block diagram showing an example of a schematic configuration of a recording/reproduction device adopting the embodiment described above. A recording/reproduction device 940 encodes, and records in a recording medium, audio data and video data of a received broadcast program, for example. The recording/reproduction device 940 may also encode, and record in the recording medium, audio data and video data acquired from another device, for example. Furthermore, the recording/reproduction device 940 reproduces, using a monitor or a speaker, data recorded in the recording medium, according to an instruction of a user, for example. At this time, the recording/reproduction device 940 decodes the audio data and the video data.

The recording/reproduction device 940 includes a tuner 941, an external interface 942, an encoder 943, an HDD (Hard Disk Drive) 944, a disc drive 945, a selector 946, a decoder 947, an OSD (On-Screen Display) 948, a control section 949, and a user interface 950.

The tuner 941 extracts a signal of a desired channel from broadcast signals received via an antenna (not shown), and demodulates the extracted signal. Then, the tuner 941 outputs an encoded bit stream obtained by demodulation to the selector 946. That is, the tuner 941 serves as transmission means of the recording/reproduction device 940.

The external interface 942 is an interface for connecting the recording/reproduction device 940 and an external appliance or a network. For example, the external interface 942 may be an IEEE 1394 interface, a network interface, an USB interface, a flash memory interface, or the like. For example, video data and audio data received by the external interface 942 are input to the encoder 943. That is, the external interface 942 serves as transmission means of the recording/reproduction device 940.

In the case the video data and the audio data input from the external interface 942 are not encoded, the encoder 943 encodes the video data and the audio data. Then, the encoder 943 outputs the encoded bit stream to the selector 946.

The HDD 944 records in an internal hard disk an encoded bit stream, which is compressed content data of a video or audio, various programs, and other pieces of data. Also, the HDD 944 reads these pieces of data from the hard disk at the time of reproducing a video or audio.

The disc drive 945 records or reads data in a recording medium that is mounted. A recording medium that is mounted on the disc drive 945 may be a DVD disc (a DVD-Video, a DVD-RAM, a DVD-R, a DVD-RW, a DVD+, a DVD+RW, or the like), a Blu-ray (registered trademark) disc, or the like, for example.

The selector 946 selects, at the time of recording a video or audio, an encoded bit stream input from the tuner 941 or the encoder 943, and outputs the selected encoded bit stream to the HDD 944 or the disc drive 945. Also, the selector 946 outputs, at the time of reproducing a video or audio, an encoded bit stream input from the HDD 944 or the disc drive 945 to the decoder 947.

The decoder 947 decodes the encoded bit stream, and generates video data and audio data. Then, the decoder 947 outputs the generated video data to the OSD 948. Also, the decoder 904 outputs the generated audio data to an external speaker.

The OSD 948 reproduces the video data input from the decoder 947 and displays a video. Also, the OSD 948 may superimpose an image of a GUI, such as a menu, a button, a cursor or the like, for example, on a displayed video.

The control section 949 includes a processor such as a CPU, and a memory such as an RAM or an ROM. The memory stores a program to be executed by the CPU, program data, and the like. A program stored in the memory is read and executed by the CPU at the time of activation of the recording/reproduction device 940, for example. The CPU controls the operation of the recording/reproduction device 940 according to an operation signal input from the user interface 950, for example, by executing the program.

The user interface 950 is connected to the control section 949. The user interface 950 includes a button and a switch used by a user to operate the recording/reproduction device 940, and a receiving section for a remote control signal, for example. The user interface 950 detects an operation of a user via these structural elements, generates an operation signal, and outputs the generated operation signal to the control section 949.

In the recording/reproduction device 940 configured in this manner, the encoder 943 has a function of the image encoding device 10 according to the embodiment described above. Also, the decoder 947 has a function of the image decoding device 60 according to the embodiment described above. Accordingly, also in the case a block is partitioned in the recording/reproduction device 940 by a partitioning method allowing various shapes other than a rectangle, the compression ratio can be increased and the image quality after decoding can be enhanced by adaptively setting a reference pixel position and predicting a motion vector.

### 5-4. Fourth Example Application

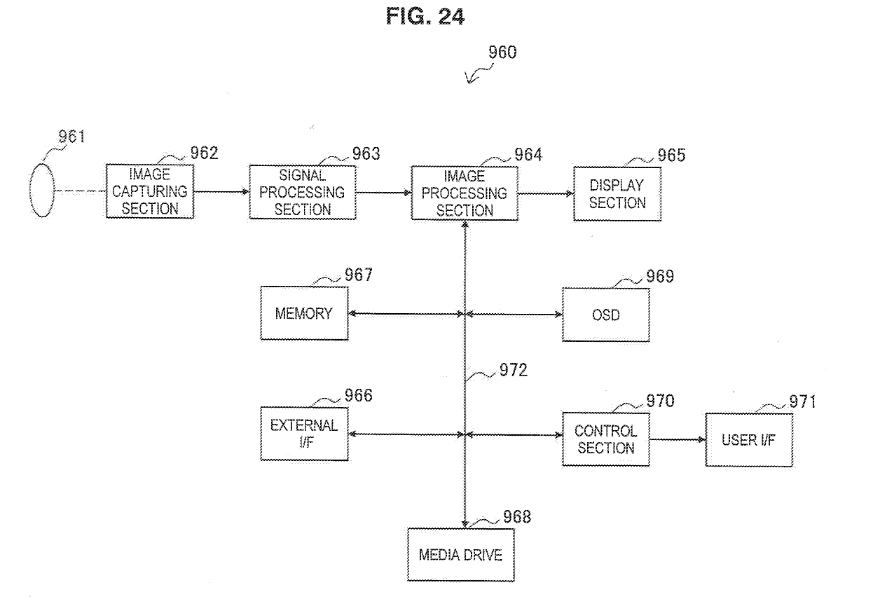

FIG. 24 is a block diagram showing an example of a schematic configuration of an image capturing device adopting the embodiment described above. An image capturing device 960 captures an image of a subject, generates an image, encodes the image data, and records the image data in a recording medium.

The image capturing device 960 includes an optical block 961, an image capturing section 962, a signal processing section 963, an image processing section 964, a display section 965, an external interface 966, a memory 967, a media drive 968, an OSD 969, a control section 970, a user interface 971, and a bus 972.

The optical block 961 is connected to the image capturing section 962. The image capturing section 962 is connected to the signal processing section 963. The display section 965 is connected to the image processing section 964. The user interface 971 is connected to the control section 970. The bus 972 interconnects the image processing section 964, the external interface 966, the memory 967, the media drive 968, the OSD 969, and the control section 970.

The optical block 961 includes a focus lens, an aperture stop mechanism, and the like. The optical block 961 forms an optical image of a subject on an image capturing surface of the image capturing section 962. The image capturing section 962 includes an image sensor such as a CCD, a CMOS or the like, and converts by photoelectric conversion the optical image formed on the image capturing surface into an image signal which is an electrical signal. Then, the image capturing section 962 outputs the image signal to the signal processing section 963.

The signal processing section 963 performs various camera signal processes, such as knee correction, gamma correction, color correction and the like, on the image signal input from the image capturing section 962. The signal processing section 963 outputs the image data after the camera signal process to the image processing section 964.

The image processing section 964 encodes the image data input from the signal processing section 963, and generates encoded data. Then, the image processing section 964 outputs the generated encoded data to the external interface 966 or the media drive 968. Also, the image processing section 964 decodes encoded data input from the external interface 966 or the media drive 968, and generates image data. Then, the image processing section 964 outputs the generated image data to the display section 965. Also, the image processing section 964 may output the image data input from the signal processing section 963 to the display section 965, and cause the image to be displayed. Furthermore, the image processing section 964 may superimpose data for display acquired from the OSD 969 on an image to be output to the display section 965.

The OSD 969 generates an image of a GUI, such as a menu, a button, a cursor or the like, for example, and outputs the generated image to the image processing section 964.

The external interface 966 is configured as an USB input/output terminal, for example. The external interface 966 connects the image capturing device 960 and a printer at the time of printing an image, for example. Also, a drive is connected to the external interface 966 as necessary. A removable medium, such as a magnetic disk, an optical disc or the like, for example, is mounted on the drive, and a program read from the removable medium may be installed in the image capturing device 960. Furthermore, the external interface 966 may be configured as a network interface to be connected to a network such as a LAN, the Internet or the like. That is, the external interface 966 serves as transmission means of the image capturing device 960.

A recording medium to be mounted on the media drive 968 may be an arbitrary readable and writable removable medium, such as a magnetic disk, a magneto-optical disk, an optical disc, a semiconductor memory or the like, for example. Also, a recording medium may be fixedly mounted on the media drive 968, configuring a non-transportable storage section such as a built-in hard disk drive or an SSD (Solid State Drive), for example.

The control section 970 includes a processor such as a CPU, and a memory such as an RAM or an ROM. The memory stores a program to be executed by the CPU, program data, and the like. A program stored in the memory is read and executed by the CPU at the time of activation of the image capturing device 960, for example. The CPU controls the operation of the image capturing device 960 according to an operation signal input from the user interface 971, for example, by executing the program.

The user interface 971 is connected to the control section 970. The user interface 971 includes a button, a switch and the like used by a user to operate the image capturing device 960, for example. The user interface 971 detects an operation of a user via these structural elements, generates an operation signal, and outputs the generated operation signal to the control section 970.

In the image capturing device 960 configured in this manner, the image processing section 964 has a function of the image encoding device 10 and the image decoding device 60 according to the embodiment described above. Accordingly, also in the case a block is partitioned in the image capturing device 960 by a partitioning method allowing various shapes other than a rectangle, the compression ratio can be increased and the image quality after decoding can be enhanced by adaptively setting a reference pixel position and predicting a motion vector.

### 6. SUMMARY

Heretofore, the image encoding device 10 and the image decoding device 60 according to an embodiment have been described using FIGS. 1 to 26. According to the present embodiment, in an image encoding method according to which a block may be partitioned by a boundary selected from a plurality of candidates including a boundary having an inclination, a reference pixel position for each partition is adaptively set according to the inclination of the boundary at the time of encoding of an image, and a motion vector to be used for prediction of a pixel value in each partition is predicted based on a motion vector set for a block or a partition corresponding to the reference pixel position. Accordingly, also in a case the unit of processing of motion compensation may take various shapes other than a rectangular partition, a motion vector can be effectively predicted by using spatial correlation or temporal correlation of motion, or both. As a result, the compression ratio of an image can be increased, and the image quality after decoding may be enhanced.

Also, according to the present embodiment, a reference pixel position to be set changed depending on whether or not a boundary overlaps at least either of the first corner and the second corner of a block that are opposite each other. Generally, the shape of a block set in an image is a rectangle, and thus, the reference pixel position for each partition formed by partitioning a block can be adaptively set according to such a standard.

Furthermore, according to the present embodiment, a co-located block or partition in a reference image corresponding to the reference pixel position which has been adaptively set can be decided. Thus, not only a prediction formula that uses spatial correlation, but also a prediction formula that uses temporal correlation or a prediction formula that uses both the spatial correlation and the temporal correlation can be used at the time of predicting a motion vector in a partitioning method such as the geometry motion partitioning, for example. It is also possible to switch between these prediction formulae for the optimal prediction formula for each block, and to use the optimal prediction formula. Therefore, further enhancement of the compression ratio of an image and/or the image quality may be expected.

Additionally, in the present specification, an example has been mainly described where the information about intra prediction and the information about inter prediction are multiplexed to the header of an encoded stream and transmitted from the encoding side to the decoding side. However, the method of transmitting these pieces of information is not limited to such an example. For example, these pieces of information may be transmitted, or recorded, as individual data that is associated with an encoded bit stream, without being multiplexed to the encoded bit stream. The term “associate” here means to enable an image included in a bit stream (or a part of an image, such as a slice or a block) and information corresponding to the image to link to each other at the time of decoding. That is, the information may be transmitted on a different transmission line from the image (or the bit stream). Or, the information may be recorded on a different recording medium (or in a different recording area on the same recording medium) from the image (or the bit stream). Furthermore, the information and the image (or the bit stream) may be associated with each other on the basis of arbitrary units such as a plurality of frames, one frame, a part of a frame or the like, for example.

The preferred embodiments of the present invention have been described above with reference to the accompanying drawings, whilst the present invention is not limited to the above examples, of course. A person skilled in the art may find various alternations and modifications within the scope of the appended claims, and it should be understood that they will naturally come under the technical scope of the present invention.

### REFERENCE SIGNS LIST

10 Image encoding device (Image processing device)
41 Partitioning section
43 Reference pixel setting section
45 Motion vector prediction section
46 Selection section
60 Image decoding device (Image processing device)
91 Boundary recognition section
92 Reference pixel setting section
94 Motion vector setting section

1. An image processing device comprising:
a partitioning section for partitioning a block set in an image into a plurality of partitions by a boundary selected from a plurality of candidates including a boundary having an inclination; and
a motion vector prediction section for predicting a motion vector to be used for prediction of a pixel value in each partition in the block partitioned by the partitioning section, based on a motion vector set for a block or a partition corresponding to a reference pixel position that changes according to the inclination of the boundary.

2. The image processing device according to claim 1, further comprising a reference pixel setting section for setting the reference pixel position for each partition according to the inclination of the boundary.

3. The image processing device according to claim 2, wherein, in a case the boundary overlaps a first corner or a second corner of the block that are located opposite each other, the reference pixel setting section sets the reference pixel position of each partition of the block to a third corner or a fourth corner different from the first corner and the second corner.

4. The image processing device according to claim 3,
wherein the first corner is a corner at a top left of the block, and
wherein, in a case the boundary does not overlap the first corner and the second corner, the reference pixel setting section sets the reference pixel position of a first partition to which the first corner belongs to the first corner.

5. The image processing device according to claim 4, wherein, in a case the boundary does not overlap the first corner and the second corner, and the second corner belongs to a second partition to which the first corner does not belong, the reference pixel setting section sets the reference pixel position of the second partition to the second corner.

6. The image processing device according to claim 1, wherein the motion vector prediction section predicts the motion vector using a prediction formula that is based on a motion vector set for a block or a partition, in a reference image, corresponding to the reference pixel position.

7. The image processing device according to claim 1, wherein the motion vector prediction section predicts the motion vector using a prediction formula that is based on a motion vector set for a block or a partition, in a reference image, corresponding to the reference pixel position and a motion vector set for another block or partition adjacent to the reference pixel position.

8. The image processing device according to claim 1,
wherein the motion vector prediction section predicts the motion vector using a first prediction formula that is based on a motion vector set for a block or a partition, in a reference image, corresponding to the reference pixel position, and predicts the motion vector using a second prediction formula that is based on a motion vector set for another block or partition adjacent to the reference pixel position, and
wherein the image processing device further comprises a selection section for selecting a prediction formula that achieves a highest encoding efficiency from a plurality of prediction formula candidates including the first prediction formula and the second prediction formula, based on a prediction result of the motion vector prediction section.

9. An image processing method for processing an image, comprising:
partitioning a block set in an image into a plurality of partitions by a boundary selected from a plurality of candidates including a boundary having an inclination; and
predicting a motion vector to be used for prediction of a pixel value in each partition in the block which has been partitioned, based on a motion vector set for a block or a partition corresponding to a reference pixel position that changes according to the inclination of the boundary.

10. An image processing device comprising:
a boundary recognition section for recognizing an inclination of a boundary, selected from a plurality of candidates including a boundary having an inclination, that partitioned a block in an image at a time of encoding of the image; and
a motion vector setting section for setting a motion vector to be used for prediction of a pixel value in each partition in a block partitioned by the boundary, based on a motion vector set for a block or a partition corresponding to a reference pixel position that changes according to the inclination of the boundary.

11. The image processing device according to claim 10, further comprising
a reference pixel setting section for setting the reference pixel position for each partition according to the inclination of the boundary recognized by the boundary recognition section.

12. The image processing device according to claim 11, wherein, in a case the boundary overlaps a first corner or a second corner of the block that are located opposite each other, the reference pixel setting section sets the reference pixel position of each partition of the block to a third corner or a fourth corner different from the first corner and the second corner.

13. The image processing device according to claim 12,
wherein the first corner is a corner at a top left of the block, and
wherein, in a case the boundary does not overlap the first corner and the second corner, the reference pixel setting section sets the reference pixel position of a first partition to which the first corner belongs to the first corner.

14. The image processing device according to claim 13, wherein, in a case the boundary does not overlap the first corner and the second corner, and the second corner belongs to a second partition to which the first corner does not belong, the reference pixel setting section sets the reference pixel position of the second partition to the second corner.

15. The image processing device according to claim 10, wherein the motion vector setting section identifies, based on information that is acquired in association with each partition, a prediction formula for a motion vector selected for the partition at a time of encoding.

16. The image processing device according to claim 15, wherein candidates for the prediction formula to be selected at a time of encoding include a prediction formula that is based on a motion vector set for a block or a partition, in a reference image, corresponding to the reference pixel position.

17. The image processing device according to claim 15, wherein candidates for the prediction formula to he selected at a time of encoding include a prediction formula that is based on a motion vector set for a block or a partition, in a reference image, corresponding to the reference pixel position and a motion vector set for another block or partition adjacent to the reference pixel position.

18. An image processing method for processing an image, comprising:
recognizing an inclination of a boundary, selected from a plurality of candidates including a boundary having an inclination, that partitioned a block set in an image at a time of encoding of the image; and
setting a motion vector to be used for prediction of a pixel value in each partition in the block partitioned by the boundary, based on a motion vector set for a block or a partition corresponding to a reference pixel position that changes according to the inclination of the boundary.
